(19) United States
(12) Patent Application Publication
(10) Pub. No.: US 2025/0260479 A1
(43) Pub. Date: Aug. 14, 2025

(54) HYBRID MULTI-ORBIT AND MULTI-PATH NETWORK ARCHITECTURE

(71) Applicant: Hughes Network Systems, LLC, Germantown, MD (US)

(72) Inventors: Billy James WHITMARSH, San Diego, CA (US); John Dennis Kenyon, Silver Spring, MD (US); Michael Gene Chin, San Diego, CA (US); George Joseph Choquette, Potomac, MD (US); Walter Robert Kepley, III, Gaithersburg, MD (US)

(73) Assignee: Hughes Network Systems, LLC, Germantown, MD (US)

(21) Appl. No.: 18/438,141

(22) Filed: Feb. 9, 2024

(51) Int. Cl. H04B 7/185; H04W 28/02; H04W 40/02

(52) U.S. Cl. CPC H04B 7/18513; H04W 28/0268; H04W 40/02

(57) ABSTRACT

Systems and methods for integrating multi-orbit and multi-path networks to provide unified wide area network (WAN) connectivity for user devices, based on combining data streams from satellite orbits and cellular networks, are provided. A system includes first wireless network connection equipment with satellite-based multi-path transport protocol, involving indoor and first outdoor device. Additionally, second wireless network connection equipment incorporates non-terrestrial-based and satellite-based multi-path transport protocol, with indoor and second outdoor device. Multi-path radio modem receives data stream, assesses network parameters to determine appropriate data transmission path, dynamically switches between networks, and modifies unified data stream accordingly. Modified data streams are provided as WAN connectivity to user device through indoor device of determined transmission path. First wireless network connection equipment includes D2D LEO modem, which includes NTN D2D antenna unit for LEO satellite communication. The connectivity between first and second outdoor device is established through IFL connection protocol comprising coaxial cable(s).

### TECHNICAL FIELD

This patent application is directed to satellite communication systems and, more specifically, to systems and methods for integrating multi-orbit (multiple orbits) and multi-path (multiple paths) networks to provide a unified wide area network (WAN) connectivity for user devices, based on combining data streams from satellite orbits and/or cellular networks.

### BACKGROUND

Generally, satellite communication systems such as high-bandwidth geosynchronous orbit satellite systems can provide high-speed data services. The geosynchronous orbit satellite systems possess a capability to cover approximately one-third of the Earth's surface from a single spacecraft. However, such geosynchronous orbit satellite systems may have a limited responsiveness for internet applications due to limitations on minimum packet round-trip time (RTT). In order to solve this problem, current direct-to-device (D2D) service providers may use low earth orbit (LEO) satellite systems, which has a RTT as low as e.g., 30 milliseconds. However, the current D2D service providers may primarily target low-bitrate data applications in handheld form factors. Current handheld form factor devices, such as smart-phones, may include low-performance antennas when considering a link to a satellite. Such low-performance antennas may not directly support fixed Internet access requirements. Therefore, the current D2D service providers may not achieve a high bandwidth and a low latency in the satellite communication systems.

For achieving this high bandwidth and the low latency, conventional systems may integrate GEO satellites with cellular technologies. This integration may provide widespread residential coverage in dynamic landscape of telecommunications. Further, this integration may include an indoor consumer premises equipment (CPE) for delivering high-speed data services. However, such integration of the GEO satellites with the cellular technologies may involve combining data streams within indoor premises, thereby necessitating additional residential space for the equipment.

Conventional networking apparatus may also receive data packets intended for transmission over a network, classify the data packets to determine a class of service, and then select an appropriate network transport for data transmission. Such selection of the appropriate network transport may be based on both the class of service assigned to the packets and measurements of expected latency associated with each of multiple network transports. However, such conventional networking apparatus does not support non-terrestrial satellite links and does not combine non-terrestrial satellite links for multi-path devices. Further, conventional combining techniques for the GEO satellite systems and the LEO satellite systems may use terrestrial wireless link (e.g., long term evolution (LTE)/fifth generation (5G)/sixth generation (6G)) for latency sensitive packets. The conventional combining techniques leads to a disparate and non-cohesive operation, where data flows exhibit either high responsiveness with low throughput or vice versa with high throughput.

Combining the latency sensitive packets from the terrestrial wireless link and latency insensitive packets from the non-terrestrial wireless link may have challenges in providing low-latency connectivity. Non-terrestrial wireless links (e.g., satellites) provide wider coverage, particularly in remote or challenging areas. On the contrary, the terrestrial networks have coverage limitations, particularly in rural areas where cellular network availability is not widespread.

Consequently, there is a need for systems and methods for addressing at least the above-mentioned problems in the existing approaches by providing systems and methods for integrating multi-orbit and multi-path networks to provide a unified wide area network (WAN) connectivity for user devices.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a system for integrating multi-orbit and multi-path networks to provide a unified wide area network (WAN) connectivity for user devices. The system includes a first wireless network connection equipment comprising a satellite-based multi-path transport protocol. The first wireless network connection equipment comprises an indoor device, and a first outdoor device. Further, the system includes a second wireless network connection equipment comprising a non-terrestrial-based multi-path transport protocol and the satellite-based multi-path transport protocol, wherein the second wireless network connection equipment comprises the indoor device, and a second outdoor device. Then at least one of the indoor device, the first outdoor device, and the second outdoor device is communicatively coupled to a multi-path radio modem. The multi-path radio modem receives data stream from at least one of the first wireless network connection equipment and the second wireless network connection equipment. The multi-path radio modem determines a type of network configuration associated with at least one of the first wireless network connection equipment and the second wireless network connection equipment, based on receiving the data stream. Further, the multi-path radio modem converts each of the data stream into a first pre-defined data format, based on the determined type of network configuration. The first pre-defined data format corresponds to a network compatible data format. Furthermore, the multi-path radio modem generates unified data stream corresponding to the received data stream, based on converting each of the data stream.

Additionally, the multi-path radio modem determines an appropriate data transmission path between the first wireless network connection equipment and the second wireless network connection equipment, based on each of a plurality of network parameters, upon generating the unified data stream. Further, the multi-path radio modem switches dynamically between at least one of the first wireless network connection equipment and the second wireless network connection equipment, based on the determined appropriate data transmission path. Furthermore, the multi-path radio modem modifies the unified data stream to a second pre-defined data format compatible with the determined appropriate data transmission path. The second pre-defined data format corresponds to at least one of a non-terrestrial-based multi-path transport protocol format and a satellite-based multi-path transport protocol format. Furthermore, the multi-path radio modem provides a wide area network (WAN) connectivity comprising the modified data streams, to a user device, through the indoor device associated with the determined appropriate data transmission path.

Another aspect of the present disclosure provides a method for integrating multi-orbit and multi-path networks to provide a unified wide area network (WAN) connectivity for user devices. The method includes receiving data stream from at least one of a first wireless network connection equipment and a second wireless network connection equipment. The first wireless network connection equipment includes a satellite-based multi-path transport protocol, and the second wireless network connection equipment includes a non-terrestrial-based multi-path transport protocol and the satellite-based multi-path transport protocol. Furthermore, the method includes determining a type of network configuration associated with at least one of the first wireless network connection equipment and the second wireless network connection equipment, based on receiving the data stream. Additionally, the method includes converting each of the data stream into a first pre-defined data format, based on the determined type of network configuration. The first pre-defined data format corresponds to a network compatible data format. Further, the method includes generating unified data stream corresponding to the received data stream, based on converting each of the data stream.

Additionally, the method includes determining an appropriate data transmission path between the first wireless network connection equipment and the second wireless network connection equipment, based on each of a plurality of network parameters, upon generating the unified data stream. Further, the method includes switching dynamically between at least one of the first wireless network connection equipment and the second wireless network connection equipment, based on the determined appropriate data transmission path. Furthermore, the method includes modifying the unified data stream to a second pre-defined data format compatible with the determined appropriate data transmission path. The second pre-defined data format corresponds to at least one of a non-terrestrial-based multi-path transport protocol format and a satellite-based multi-path transport protocol format. Additionally, the method includes providing a wide area network (WAN) connectivity comprising the modified data streams, to a user device, through at least one of an indoor device associated with the determined appropriate data transmission path. The first wireless network connection equipment comprises the indoor device, and a first outdoor device, and the second wireless network connection equipment comprises the indoor device, and a second outdoor device.

Yet another aspect of the present disclosure provides a non-transitory computer-readable medium comprising machine-readable instructions. The machine-readable instructions are executable by a processor to receive data stream from at least one of a first wireless network connection equipment and a second wireless network connection equipment. The first wireless network connection equipment comprises a satellite-based multi-path transport protocol, and the second wireless network connection equipment comprises a non-terrestrial-based multi-path transport protocol and the satellite-based multi-path transport protocol. The processor determines a type of network configuration associated with at least one of the first wireless network connection equipment and the second wireless network connection equipment, based on receiving the data stream. Further, the processor converts each of the data stream into a first pre-defined data format, based on the determined type of network configuration.

The pre-defined data format corresponds to a network compatible data format. Furthermore, the processor generates unified data stream corresponding to the received data stream, based on converting each of the data stream. Additionally, the processor determines an appropriate data transmission path between the first wireless network connection equipment and the second wireless network connection equipment, based on each of a plurality of network parameters, upon generating the unified data stream.

Further, the processor performs dynamically switching between at least one of the first wireless network connection equipment and the second wireless network connection equipment, based on the determined appropriate data transmission path. Further, the processor modifies the unified data stream to a second pre-defined data format compatible with the determined appropriate data transmission path. The second pre-defined data format corresponds to at least one of a non-terrestrial-based multi-path transport protocol format and a satellite-based multi-path transport protocol format. Furthermore, the processor provides a wide area network (WAN) connectivity comprising the modified data streams, to a user device, through an indoor device associated with the determined appropriate data transmission path. The first wireless network connection equipment comprises the indoor device, and a first outdoor device, and the second wireless network connection equipment comprises the indoor device, and a second outdoor device.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

Features of the disclosed embodiments are illustrated by way of example and not limited in the following Figure(s), in which like numerals indicate like elements, in which:

FIG. 1 illustrates a block diagram representation of a system for integrating multi-orbit and multi-path networks to provide a unified wide area network (WAN) connectivity for user devices, according to an example.

FIG. 2 illustrates a block diagram representation of a multi-path radio modem, such as those shown in FIG. 1, according to an example.

FIG. 3 illustrates a block diagram representation of a network architecture for a system, which includes a single dual orbit-based geostationary earth orbit (GEO) outdoor device and/or low earth orbit (LEO) outdoor device, according to an example.

FIG. 4A illustrates a block diagram representation of a network architecture for a system, which includes an integrated multi-path-based geostationary earth orbit (GEO) outdoor device and/or cellular network-based outdoor device, according to an example.

FIG. 4B illustrates a block diagram representation of a network architecture for a system, which includes a geostationary earth orbit (GEO) outdoor device and/or cellular network-based outdoor device connected using a multimedia over coax alliance (MoCA) connection protocol, according to an example.

FIG. 4C illustrates a block diagram representation of a network architecture for (a) a system, which includes a geostationary earth orbit (GEO) outdoor device and/or cellular network-based outdoor device connected using (b) a multimedia over coax alliance (MoCA) connection protocol and an interconnect facility link (IFL) connection protocol comprising a single coaxial cable, according to an example.

FIG. 4D illustrates a block diagram representation of a network architecture for a system, which includes a geostationary earth orbit (GEO) outdoor device and/or cellular network-based outdoor device connected using a multimedia over coax alliance (MoCA) connection protocol and an interconnect facility link (IFL) connection protocol comprising a dual coaxial cable, according to an example.

FIG. 5A illustrates a block diagram representation of a network architecture for a system, which includes a geostationary earth orbit (GEO) outdoor device and a low earth orbit (LEO) outdoor device (i.e., two outdoor devices) connected using a multimedia over coax alliance (MoCA) connection protocol, according to an example.

FIG. 5B illustrates a block diagram representation of a network architecture for a system, which includes a geostationary earth orbit (GEO) outdoor device, a low earth orbit (LEO) outdoor device, and a multi-path radio modem (i.e., three outdoor devices) connected using a multimedia over coax alliance (MoCA) connection protocol, according to an example.

FIG. 6 illustrates a block diagram representation of hardware platform for implementation of a computer system, according to an example.

FIG. 7 illustrates a flow diagram representation of a method of integrating multi-orbit and multi-path network to provide a unified wide area network (WAN) connectivity for user devices, according to an example.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the proposed approach and solutions are described by referring mainly to examples and embodiments thereof. In the following description, numerous specific details are set forth in order to provide a thorough understanding of the proposed approach and solutions. It will be readily apparent, however, that the proposed approach and solutions may be practiced without limitation to these specific details. In other instances, some methods and structures readily understood by one of ordinary skill in the art have not been described in detail so as not to unnecessarily obscure the ongoing description. As used herein, the terms “a” and “an” are intended to denote at least one of a particular element, the term “includes” means includes but not limited to, the term “including” means including but not limited to, and the term “based on” means based at least in part on, the term “based upon” means based at least in part upon, and the term “such as” means such as but not limited to. The term “relevant” means closely connected or appropriate to what is being performed or considered.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules.

A computer system (standalone, client or server computer system) configured by an application may constitute a “module” (or “subsystem”) that is configured and operated to perform certain operations. In one example, the “module” or “subsystem” may be implemented mechanically or electronically, so a module includes dedicated circuitry or logic that is permanently configured (within a special-purpose processor) to perform certain operations. In another example, a “module” or s “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

In some implementations, networking devices may manage traffic over multiple wide area network (WAN) transport modems, for example, different physical network interfaces or physical connections, to provide high performance in different situations. Multiple network transport modems may be used concurrently, with devices selecting the network transport modem to be used for each packet or group of packets according to the requirements of requesting applications. For example, a network device may include a classifier that classifies packets as an interactive traffic (e.g., web pages) or a bulk traffic (e.g., streaming media, file downloads, and/or other file types.). The network device may then select a best available network transport path/modem for each type of the traffic and use the selected transport modem to transmit the data.

As an example, a router may have access to a first network transport modem and a second network transport modem, with both being available concurrently and both providing different performance characteristics. The router may use a classifier to assign packets to be transmitted to different classes, for example, different classes of service, and then use the class assignments and expected latencies for transmission to select which network transport modem to use to transmit the packets. For example, the router may select, to send packets that are not sensitive to latency (e.g., bulk transfers) over the network transport modem having a lowest data usage cap, lowest cost, highest throughput, and/or other advantages. For packets that are very latency-sensitive, the router may select to send packets over a lowest-latency connection.

The multiple network transport modems may be available concurrently and the network device may concurrently use both transport modems. This may include splitting a single Internet Protocol (IP) flow across the multiple transport modems, which may often provide overall latency, throughput, and other performance results. Such network devices may establish a packet tunnel for each different network transport modem and tunneled packets may include resequencing information, such as an IP flow identifier and a sequence number indicating a position of the packet in the sequence. At the receiving side, the packets received through multiple tunnels may be “un-tunneled” and the various IP flows may be reconstructed based on re-sequencing of the information.

The selection of a network transport modem may be performed at a fine-grained level, e.g., for each packet or group of packets. The selection of a network transport modem for a given packet may also account for dynamically changing network conditions of the associated communication network. Rather than simply assuming that the baseline or ideal conditions prevail for the different network transport modems, the network device may use observed and actual network conditions for the network transport modems to estimate the latency that would be experienced at that instant time and for the specific packet being processed.

The disclosed technology falls generally within the field of networking technology and deals with the subjects of: an internet access, including with applications to virtual private network (VPN) provided private networking, a WAN optimization, e.g., whereby existing internet and VPN networking is optimized or improved to provide for quality-of-service (QOS) overlay which support with multiple classes of services across a broadband connection which does not support QoS itself, a satellite communications, e.g., where geosynchronous satellites may provide ubiquitous connectivity but operate with an order of magnitude higher latency than terrestrial network connectivity and where TCP spoofing may be used to reduce the effect of latency on bulk transfer throughput, wireless cell phone-oriented networking, e.g., using technologies such as a non-terrestrial based fourth generation (4G), non-terrestrial based long term evolution (LTE), and a non-terrestrial based fifth generation (5G), sixth generation (6G), and/or other non-terrestrial based technologies, to provide wireless connectivity to the internet; wide area networking (WAN), e.g., where multiple (typically two) broadband transports are combined to provide better service and availability than what is provided by either transport individually.

The techniques described herein may be referred to as an agile-switching active-path (ASAP) feature that may be used in acceleration appliances and other WAN optimization technologies. As discussed below, the system may adaptively switch between using satellite-based network access technology and other network access technology (e.g., cellular network access, wired network access, etc.), or provide different types of traffic on the different access technologies, to achieve, for example, improved throughput, lower latency, lower cost, and other benefits.

Various examples of systems and methods for integrating multi-orbit and multi-path networks to provide a unified wide area network (WAN) connectivity for user devices, based on combining data streams from satellite orbits and cellular networks, may be provided. The system includes a first wireless network connection equipment comprising a satellite-based multi-path transport protocol. The first wireless network connection equipment includes an indoor device, and a first outdoor device. Further, the system includes a second wireless network connection equipment comprising a non-terrestrial-based multi-path transport protocol and the satellite-based multi-path transport protocol. The second wireless network connection equipment includes the indoor device, and a second outdoor device. Further, at least one of the indoor device, the first outdoor device, and the second outdoor device is communicatively coupled to a multi-path radio modem. The multi-path radio modem receives data stream from at least one of the first wireless network connection equipment and the second wireless network connection equipment. Further, the multi-path radio modem determines a type of network configuration associated with at least one of the first wireless network connection equipment and the second wireless network connection equipment, based on receiving the data stream. Further, the multi-path radio modem converts each of the data stream into a first pre-defined data format, based on the determined type of network configuration. The pre-defined data format corresponds to a network compatible data format.

Additionally, the multi-path radio modem generates unified data stream corresponding to the received data stream, based on converting each of the data stream. Further, the multi-path radio modem determines an appropriate data transmission path between the first wireless network connection equipment and the second wireless network connection equipment, based on each of a plurality of network parameters, upon generating the unified data stream. Furthermore, the multi-path radio modem switches dynamically between at least one of the first wireless network connection equipment and the second wireless network connection equipment, based on the determined appropriate data transmission path. Further, the multi-path radio modem modifies the unified data stream to a second pre-defined data format compatible with the determined appropriate data transmission path. The second pre-defined data format corresponds to at least one of a non-terrestrial-based multi-path transport protocol format and a satellite-based multi-path transport protocol format. Further, the multi-path radio modem provides a wide area network (WAN) connectivity comprising the modified data streams, to a user device, through the indoor device associated with the determined appropriate data transmission path.

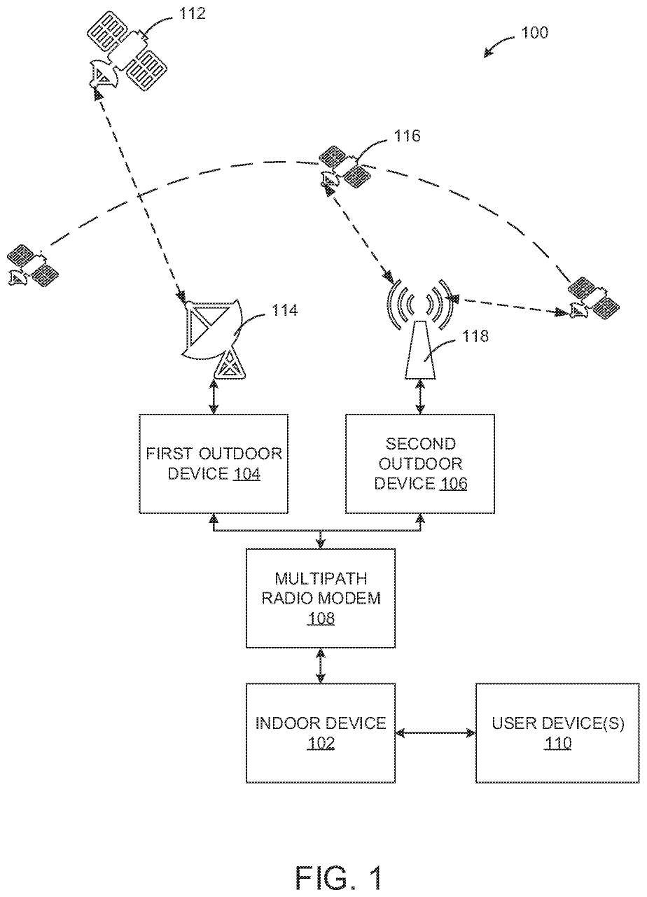

FIG. 1 illustrates a block diagram representation of a system 100 for integrating multi-orbit (multiple orbits) and multi-path (multiple paths) networks to provide a unified wide area network (WAN) connectivity for user devices, according to an example. In some examples, the system 100 may depict a satellite communication system capable of providing at least one of voice and/or data services. In some examples, the satellite communication may be a low Earth orbit (LEO) system, a medium Earth orbit (MEO) system, a geostationary orbit (GEO) system, any other orbit/satellite systems, and combination thereof.

In an example, the system 100 may include a first wireless network connection equipment (not shown) and a second wireless network connection equipment (not shown). The first wireless network connection equipment may include a satellite-based multi-path transport protocol. The first wireless network connection equipment may include an indoor device 102, and a first outdoor device 104. For example, the indoor device 102, and the first outdoor device 104 may be communicatively coupled using at least one of a coax splitter protocol, a multimedia over coax alliance (MoCA) connection protocol, and the like. The first outdoor device 104 may be powered using a direct current (DC) power connection protocol between the indoor device 102 and the first outdoor device 104.

In an example, the MoCA may enable the distribution of high-speed data, particularly in-home networking over existing coaxial cable infrastructure. The MoCA may allow devices to communicate over the same coaxial cables that are used for cable television and, in some cases, internet service. The MoCA may be used to extend the home network to areas where Wi-Fi signals might be weaker. In a scenario, MoCA adapters may be used to connect to the modems or routers at each end of the coaxial cable. The MoCA adapters turn the coaxial cable into a high-speed networking path. A MoCA connection between modems involves connecting a MoCA adapter to each modem or router using the Ethernet ports on the devices. The MoCA adapters then use the existing coaxial cable infrastructure to transmit data between the two locations. The data, such as internet traffic, may be carried over the coaxial cables, providing a wired connection between the modems. This can result in a more reliable and faster connection compared to some wireless alternatives, especially in areas where Wi-Fi signals may be weaker.

Further, the second wireless network connection equipment may include a non-terrestrial-based multi-path transport protocol and the satellite-based multi-path transport protocol. The second wireless network connection equipment may include the indoor device 102 and a second outdoor device 106. For example, the indoor device 102 and the second outdoor device 106 may be communicatively coupled using, but not limited to, the coax splitter protocol, the MoCA connection protocol, an interconnect facility link (IFL) protocol, and the like. Further, the second outdoor device 106 may be powered using the DC power connection protocol between the indoor device 102 and the second outdoor device 106. For example, the MoCA connection protocol and the IFL connection protocol includes a plurality of operational configurations and frequency ranges corresponding to at least one of the first indoor device 102, the first outdoor device 104, and the second outdoor device 106.

The IFL connection protocol may be a cable system that may be used in facilities to connect an outdoor unit and an indoor unit. For example, in satellite internet installations, especially those in residential or small business settings, the IFL using a single RG6 cable might connect an outdoor satellite dish to an indoor modem or router. In broadcasting or communication systems, an IFL using a single RG6 cable could be part of the infrastructure connecting various components within a facility, such as linking antennas, receivers, or transmitters. In certain in-building wireless systems, a single RG6 cable may serve as the IFL connection link connecting different components within a building, such as antennas, amplifiers, or repeaters. In general RF applications, an IFL using RG6 might be employed for various purposes where a single coaxial cable is sufficient to carry signals over short distances.

The indoor device 102, and/or the first outdoor device 104, and/or the second outdoor device 106 may be communicatively coupled to a multi-path radio modem 108. The communication protocol between the indoor device 102, and/or the first outdoor device 104, and/or the second outdoor device 106 and/or the multi-path radio modem 108 may include, but is not limited to, a coax splitter protocol, a multimedia over coax alliance (MoCA) protocol, an interconnect facility link (IFL) protocol, a transmission control protocol/internet protocol (TCP/IP), serial communication protocol, any other communication protocol, and combinations thereof. Further, one or more user devices 110 may be communicatively coupled to the indoor device 102 for providing WAN connectivity to the one or more user devices 110.

Further, the first wireless network connection equipment may include a geosynchronous Earth orbit (GEO) modem (not shown in FIG. 1), and a direct to device (D2D) low Earth orbit (LEO) modem (not shown in FIG. 1) integrated into the first outdoor device 104. The second wireless network connection equipment comprises a Geosynchronous Earth Orbit (GEO) modem, and a non-terrestrial based heterogenous cellular modem integrated into at least one of the second outdoor device, and the second indoor device. The unified data stream associated with the GEO and the non-terrestrial based heterogenous cellular modem comprises latency-insensitive Internet Protocol (IP) packets associated with the satellite-based multi-path transport protocol. The D2D LEO modem includes a non-terrestrial network (NTN) Device-to-Device (D2D) antenna unit for a LEO satellite communication. Further, the NTN D2D antenna unit may connect, via a multi-WAN access module, to a terrestrial cellular network or a LEO satellite network based on a location and available network conditions. It should be noted that, a D2D over LEO modem may be operating in a fixed wireless application. The NTN D2D antenna unit may be designed for higher gain as, the NTN D2D antenna unit may not include the same head/hand effect concerns as a handheld device. This additional gain may further improve latency and throughput, and system efficiency over the satellite system.

Further, the NTN D2D antenna unit may communicate with the LEO satellite with signal reception and transmission capabilities as a fixed and a high-gain antenna. Furthermore, the NTN D2D antenna or its modem unit may determine an appropriate network path between a terrestrial path and a satellite path, based on real-time network parameters comprising at least one of a signal strength, a bandwidth availability, and a latency.

The first outdoor device 104 may be communicatively coupled to a GEO satellite system 112 via a first antenna unit 114. Further, the second outdoor device 106 may be communicatively coupled to a LEO satellite system 116 via a second antenna unit 118. The first antenna unit 114 and the second antenna unit 118 may include, but not limited to, a directional antenna, an omni-antenna, a single directional antenna, a directional stub (i.e., stubby or shortened structure), a helical antenna, dual receiver antennas, and the like, and combinations thereof.

In an example, the indoor device 102, the multi-path radio modem 108 may correspond to a mobile wireless modem/terminal, and the first outdoor device 104, the second outdoor device 106 may correspond to a mobile satellite/non-terrestrial modem/terminal. Although, the indoor device 102, the first outdoor device 104, the second outdoor device 106, and the multi-path radio modem 108 may typically remain in the same location once mounted, the modems/devices/terminals may be removed from their mounts, relocated to another location, and/or may be configured to be mobile terminals. For example, the radio modems/devices may be mounted on mobile platforms that facilitate transportation thereof from one location to another. Such mobile platforms may include, for example, any number of mobile vehicles, such as airplanes, cars, buses, boats, trucks, troop-carriers, or other vehicles, and/or other types of vehicles/transporting means. It should be appreciated that such radio modems may be operational when still and not while being transported. That said, there may be scenarios where the transport modems may be transportable (mobile) terminals that remain operational during transit.

In an example, the system 100 may be implemented as a standalone device such as a networking apparatus or device. In an example, each of the indoor device 102, the first outdoor device 104, the second outdoor device 106, and the multi-path radio modem 108, may be implemented as a standalone device. In another example, the indoor device 102, the first outdoor device 104, the second outdoor device 106, and the multi-path radio modem 108 may be implemented and integrated into an existing network device/network apparatus such as a mobile modem/device/terminal.

The mobile modem/device/terminal may be used in scenarios of, for example, more frequent occurrence of outages on one or more wide area network (WAN) connections due to the signal being physically blocked or interfered with (e.g. tunnels, tall buildings, hills, and mountains, and/or other obstacles.), brief outages occurring when shifting from one spot beam to another spot beam, and/or one satellite to another satellite, or one wireless cell to another wireless cell, variations in performance including capacity when shifting from one spot beam to another spot beam, and/or one satellite to another satellite, or one wireless cell to another wireless cell, variations in performance including capacity when the mobile terminal moves from an edge to a center of a spot beam or vice a versa, and/or other mobility scenarios.

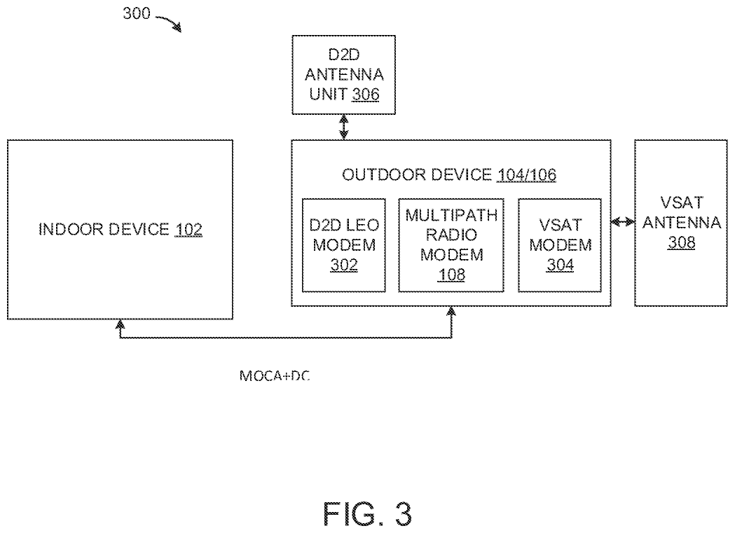

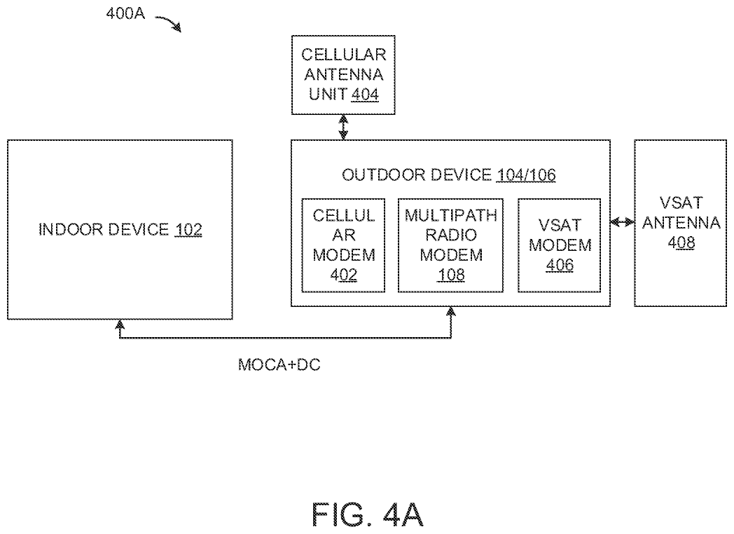

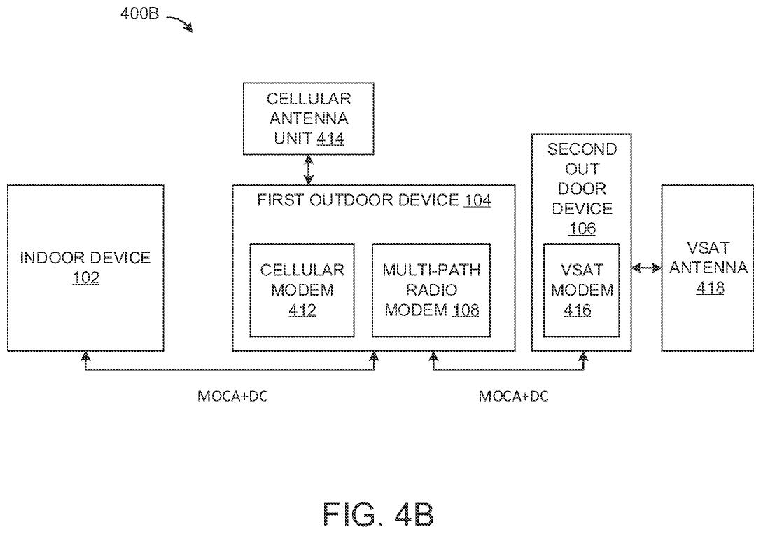

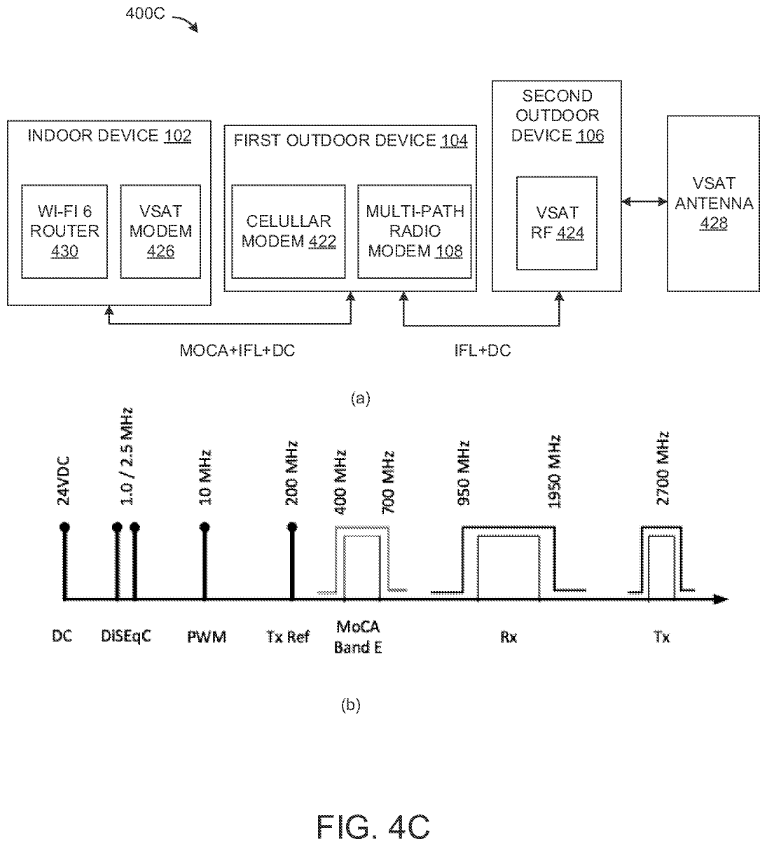

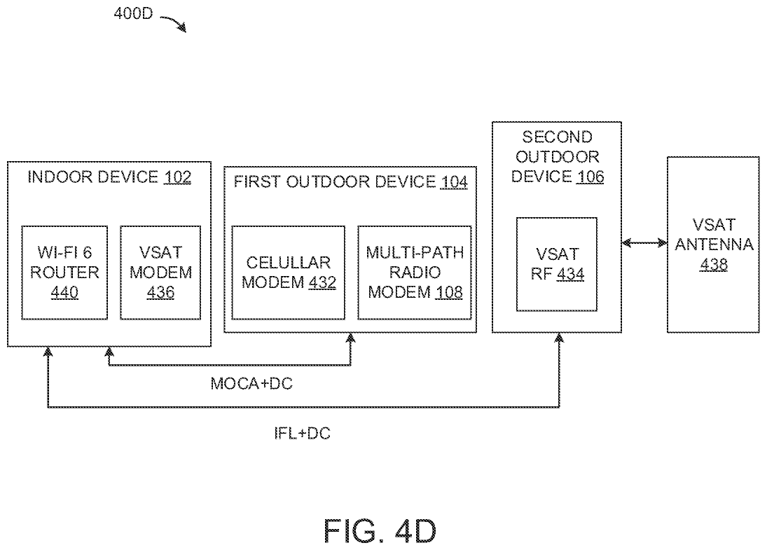

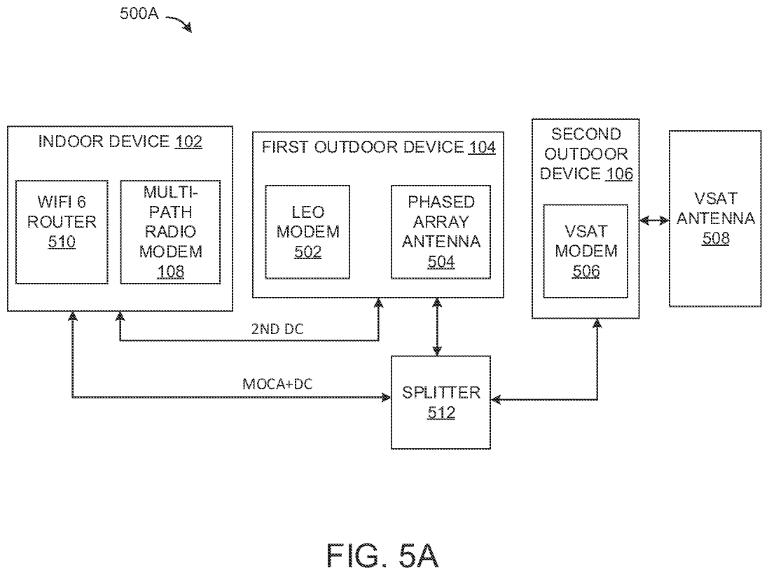

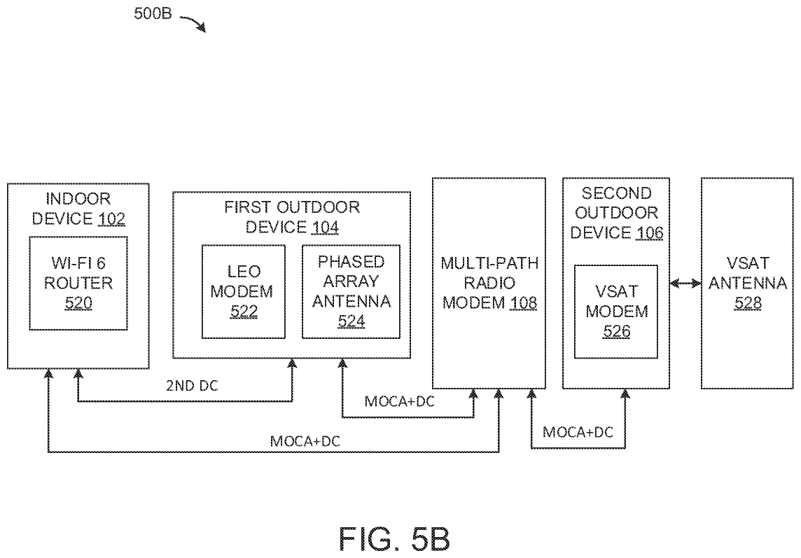

The system 100 or network architecture may include other system elements or components and is not limited to the components shown in FIG. 1. For example, the system may include a software defined radio (SDR) modem/gateway, a network transport modem, a single dual orbit-based GEO outdoor device and/or LEO outdoor device as shown in FIG. 3, an integrated multi-path-based GEO outdoor device and/or cellular network-based outdoor device as shown in FIG. 4A, a GEO outdoor device and/or cellular network-based outdoor device connected using a multimedia over coax alliance (MoCA) connection protocol as shown in FIG. 4B, a GEO outdoor device and/or cellular network-based outdoor device connected using a MoCA connection protocol and an interconnect facility link (IFL) connection protocol comprising a single coaxial cable as shown in FIG. 4C, a GEO outdoor device and/or cellular network-based outdoor device connected using a MoCA connection protocol and an IFL connection protocol comprising a dual coaxial cable as shown in FIG. 4D, a GEO and a LEO outdoor device (i.e., two outdoor devices) connected using MoCA connection protocol as shown in FIG. 5A, and a GEO and a LEO outdoor device, and a multi-path radio modem (i.e., three outdoor devices) connected using a MoCA connection protocol as shown in FIG. 5B. The disclosed technology may be implemented in different ways as shown in FIGS. 3 to 5B (system 300, system 400A, system 400B, system 400C, system 400D, system 500A, and system 500B).

It should be appreciated that the network architecture or the system 100 and the system(s) are depicted in FIGS. 1-5B may be a few example implementations. Hence, the system 100 may or may not include additional features and some of the features described herein may be removed and/or modified without departing from the scope of the system 100 outlined herein.

In some examples, the system 100 may also include a private network and/or public network (not shown in FIGS. 1-5B). The private network and/or public network may include any variations of networks. For example, the private network may be a local area network (LAN), and the public network may be a wide area network (WAN). Also, the private network and/or public network may each be a local area network (LAN), wide area network (WAN), the Internet, a cellular network, a cable network, a satellite network, or other network that facilitates communication between the components of the system 100 as well as any external element or system connected to the private network and/or public network. The private network and/or public network may further include one, or any number, of the exemplary types of networks mentioned above operating as a stand-alone network or in cooperation with each other. For example, the private network and/or public network may utilize one or more protocols of one or more clients or servers to which they are communicatively coupled. The private network and/or public network may facilitate the transmission of data according to a transmission protocol of any of the devices and/or systems in the private network and/or public network. Although each of the private network and/or public network may be a single network, it should be appreciated that in some examples, each of the private network and/or public network may include a plurality of interconnected networks as well.

Further, the system 100 may include terminals (not shown in FIGS. 1-5B) which may be used by, but is not limited to, a user, a customer, an administrator, a network operator, a flight/ship operator, a driver, and/or type of users. Depending on the application, the terminals may include or incorporate any number of antenna dishes, which may be provided in various sizes, depths, or dimensions (e.g., small, medium, or large). Although the terminals may typically remain in the same location once mounted, the terminals may be removed from their mounts, relocated to another location, and/or may be configured to be mobile terminals. For example, the terminals may be mounted on mobile platforms that facilitate transportation thereof from one location to another. Such mobile platforms may include, for example, any number of mobile vehicles, such as airplanes, cars, buses, boats, trucks, troop-carriers, or other vehicles, and/or other type of vehicles/commuting means. It should be appreciated that such terminals may be operational when still and not while being transported. That said, there may be scenarios where the terminals may be transportable (mobile) terminals that remain operational during transit. As used herein, the terms “terminal,” “customer terminal,” “satellite terminal,” and/or “very small aperture terminal (VSAT)” may be used interchangeably to refer to these terminal types.

It should be appreciated that any number of customer-premise equipment (CPE) (not shown in FIGS. 1-5B) may be communicatively coupled to the modems/devices/terminals. In some examples, the CPE may include any number of computing or mobile devices. For example, such a computing or mobile device may include, but is not limited to, a laptop, a tablet, a mobile phone, an appliance, a camera, a sensor, a thermostat, a vehicle, a display, and/or other interfaces. In general, the CPE may include, without limitation, any number of network-enabled computing devices, elements, or systems. It should be appreciated that a network of such devices may be commonly referred to as internet of things (IoT). The CPE may be provided as a standalone, transport integrated, hybrid integrated, or fully integrated single device solution. In the standalone configuration, all WAN modems and accelerators are provided as standalone devices.

Further, the system 100 may include a satellite (e.g., GEO satellite system 112, LEO satellite system 116) which may be an object intentionally placed into respective orbits around the Earth. In some examples, the satellite may be an artificial satellite that may be configured to transmit and receive data signals. For example, the satellite may, from one or more beams and provide connectivity between at least the terminals and the first outdoor device/second outdoor device. More specifically, the satellite may communicate data signals using the beams with the terminals via a terminal return channel and a terminal forward channel, and with the gateway via a gateway return channel and a gateway forward channel (not shown). It should be appreciated that the satellite may, from any number of beams to communicate data signals with any number of components, even beyond the terminals or the gateway.

In some examples, the satellite may include, but is not limited to, a transponder satellite, a regenerative satellite, and/or other similar satellite that may generate one or more spot beams. Furthermore, in some examples, the satellite may operate in geosynchronous, mid-earth, low-earth, elliptical, or some other orbital configuration. For example, a geostationary earth orbit (GEO) spot beam, a low-earth orbit (LEO) satellite, a medium earth orbit spot beam, and/or other type of spot beam.

While the processors, components, elements, systems, subsystems, and/or other computing devices may be shown as single components or elements, one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more modems/devices/servers. Furthermore, it should be appreciated that some of the middleware may or may not be needed to achieve functionality. Other types of servers, middleware, systems, platforms, and applications not shown may also be provided at the front-end or back-end to facilitate the features and functionalities of the system 100, and components, as shown in FIGS. 1-5B.

In an example, the system 100 may configure the multi-path radio modem 108 to receive data stream from at least one of the first wireless network connection equipment and the second wireless network connection equipment.

In an example, the system 100 may configure the multi-path radio modem 108 to determine a type of network configuration associated with at least one of the first wireless network connection equipment and the second wireless network connection equipment, based on receiving the data stream.

In an example, the system 100 may configure the multi-path radio modem 108 to convert each of the data stream into a first pre-defined data format, based on the determined type of network configuration. The first pre-defined data format corresponds to a network compatible data format.

In an example, the system 100 may configure the multi-path radio modem 108 to generate unified data stream corresponding to the received data stream, based on converting each of the data stream. For example, the first wireless network connection equipment using the indoor device 102 may establish an auxiliary path associated with the first wireless network connection equipment, for transmitting the unified data stream. The unified data stream from the first wireless network connection equipment includes latency-sensitive Internet Protocol (IP) packets associated with the satellite-based multi-path transport protocol.

In an example, the system 100 may configure the multi-path radio modem 108 to determine an appropriate data transmission path between the first wireless network connection equipment and the second wireless network connection equipment, based on each of a plurality of network parameters, upon generating the unified data stream. The plurality of parameters includes, but not limited to, a classification of the user traffic associated with the generated unified data stream, a latency parameter associated with the first wireless network connection equipment and the second wireless network connection equipment, a bandwidth parameter associated with the first wireless network connection equipment and the second wireless network connection equipment, a quality of service (QOS) required for the user traffic, and the like.

Further, for determining the appropriate data transmission path between the first wireless network connection equipment and the second wireless network connection equipment, based on each of the plurality of network parameters, the system 100 may configure the multi-path radio modem 108 to determine a quality of service (QOS) required for a user traffic associated with the generated unified data stream. In an example, the system 100 may configure the multi-path radio modem 108 to classify the user traffic associated with the generated unified data stream, based on determining the quality of service (QOS). In an example, the system 100 may configure the multi-path radio modem 108 to determine at least one of a latency parameter and a bandwidth parameter associated with the first wireless network connection equipment and the second wireless network connection equipment, upon classifying the user traffic.

In an example, the system 100 may configure the multi-path radio modem 108 to switch dynamically between at least one of the first wireless network connection equipment and the second wireless network connection equipment, based on the determined appropriate data transmission path.

In an example, the system 100 may configure the multi-path radio modem 108 to modify the unified data stream to a second pre-defined data format compatible with the determined appropriate data transmission path. The second pre-defined data format corresponds to at least one of a non-terrestrial-based multi-path transport protocol format and a satellite-based multi-path transport protocol format.

In an example, the system 100 may configure the multi-path radio modem 108 to provide a wide area network (WAN) connectivity with the modified data streams, to the user device 110, through the indoor device 102 associated with the determined appropriate data transmission path.

The examples of the systems and methods herein may be used in mobile internet access, including with applications to a virtual private network (VPN) provided private networking. Further, systems and methods herein may enable WAN optimization, in which existing Internet and VPN networking may be optimized or improved to provide for a quality-of-service (QOS) overlay which supports multiple classes of services across a broadband connection, which does not support QoS itself. Furthermore, systems and methods herein may be used in mobile satellite communications.

For example, where geosynchronous satellites may provide ubiquitous connectivity, however, operate with an order of magnitude higher latency than terrestrial network connectivity. Additionally, systems and methods herein may be used in wireless cell phone-oriented networking, using technologies such as a non-terrestrial fifth generation (5G), a non-terrestrial sixth generation (6G), a non-terrestrial new radio (NR), to provide wireless connectivity via Internet to the user device(s) 110. Further, the systems and methods herein may be used in the SDR, where multiple (typically two) broadband transport modems are combined to provide better service and availability than what is provided by either transport individually. The software radio, also known as the software-defined radio (SDR), refers to a communication system in which components that have traditionally been implemented in hardware, such as mixers, filters, amplifiers, modulators, and demodulators, are instead implemented using software on a personal computer or other embedded computing devices. This approach provides flexibility, reconfigurability, and programmability to radio systems.

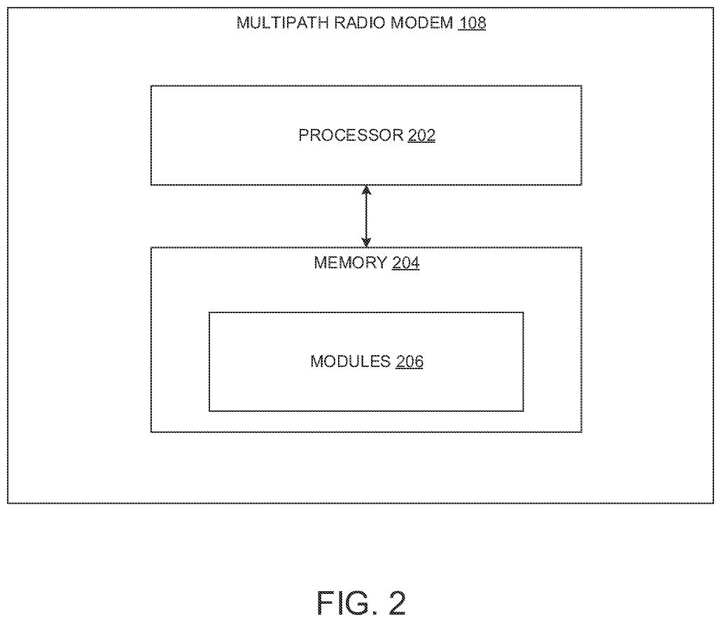

FIG. 2 illustrates a block diagram representation of a multi-path radio modem 108, such as those shown in FIG. 1, according to an example. The multi-path radio modem 108 may include a processor 202, and a memory 204. The memory 204 may include processor-executable instructions, which on execution, cause the processor 202 to perform one or more operations described herein. The memory 204 may include one or more modules 206. The modules 206 may include, but are not limited to, a receiving module, a determining module, a converting module, a generating module, a classifying module, a switching module, a modifying module, a providing module, and/or other modules (not shown in FIGS.). Each of these modules when executed by the processor 202 may perform one or more functionalities described in the context of the system 100, system 300, system 400A, system 400B, system 400C, system 400D, system 500A, and system 500B.

In an example, configuration and working of the multi-path radio modem 108 may be similar to the system 100. It should be appreciated that the multi-path radio modem 108 depicted in FIG. 2 may be an example. Hence, multi-path radio modem 108 may or may not include additional features and some of the features described herein may be removed and/or modified without departing from the scopes of the multi-path radio modem 108 outlined herein.

In an example, the receiving module may receive data stream from at least one of the first wireless network connection equipment and the second wireless network connection equipment. In an example, the determining module may determine a type of network configuration associated with at least one of the first wireless network connection equipment and the second wireless network connection equipment, based on receiving the data stream.

In an example, the converting module may convert each of the data stream into a first pre-defined data format, based on the determined type of network configuration. The first pre-defined data format corresponds to a network compatible data format. In an example, the generating module may generate unified data stream corresponding to the received data stream, based on converting each of the data stream.

In an example, the determining module may determine an appropriate data transmission path between the first wireless network connection equipment and the second wireless network connection equipment, based on each of a plurality of network parameters, upon generating the unified data stream. The plurality of parameters includes, but not limited to, a classification of the user traffic associated with the generated unified data stream, a latency parameter associated with the first wireless network connection equipment and the second wireless network connection equipment, a bandwidth parameter associated with the first wireless network connection equipment and the second wireless network connection equipment, a quality of service (QOS) required for the user traffic, and the like.

Further, for determining the appropriate data transmission path between the first wireless network connection equipment and the second wireless network connection equipment, based on each of the plurality of network parameters, the determining module may determine a quality of service (QOS) required for a user traffic associated with the generated unified data stream. In an example, the classifying module may classify the user traffic associated with the generated unified data stream, based on determining the quality of service (QOS). In an example, the determining module may determine at least one of a latency parameter and a bandwidth parameter associated with the first wireless network connection equipment and the second wireless network connection equipment, upon classifying the user traffic.

In an example, the switching module may switch dynamically between at least one of the first wireless network connection equipment and the second wireless network connection equipment, based on the determined appropriate data transmission path. In an example, the modifying module may modify the unified data stream to a second pre-defined data format compatible with the determined appropriate data transmission path. The second pre-defined data format corresponds to at least one of a non-terrestrial-based multi-path transport protocol format and a satellite-based multi-path transport protocol format. In an example, the providing module may provide a wide area network (WAN) connectivity with the modified data streams, to the user device 110, through the indoor device 102 associated with the determined appropriate data transmission path.

For example, the non-terrestrial network may relate to communication networks that involve satellites or other non-Earth-based infrastructure. Non-terrestrial networks may have role in various applications, including satellite communication, space-based internet, and satellite constellations. In an example, in the satellite communication networks, non-terrestrial networks often refer to satellite communication systems, where satellites orbiting the Earth facilitate global communication by relaying signals between ground stations and/or directly to user terminals. Further, in space-based internet and satellite constellations, researchers may be working on deploying constellations of small satellites in low Earth orbit (LEO) to provide global internet coverage. These non-terrestrial networks aim to overcome some of the limitations of traditional geostationary satellite systems, such as lower latency and higher data throughput. Furthermore, in interplanetary communication, non-terrestrial networks could also include communication systems designed for space exploration and interplanetary missions, where communication links extend beyond Earth.

FIG. 3 illustrates a block diagram representation of a network architecture for a system 300, which includes a single dual orbit-based geostationary earth orbit (GEO) outdoor device (e.g., very small aperture terminal (VSAT) modem 304), and/or low earth orbit (LEO) outdoor device (e.g., D2D LEO modem 302), according to an example. For example, using the system 300 an integrated dual-orbit outdoor modem with D2D antenna and VSAT connectivity may be implemented for global coverage. The integrated outdoor modem 104 and/or 106 may be implemented for seamless communication across single dual orbits, specifically the GEO and the LEO.

In an example, consider a third-generation partnership project (3GPP) based modem and a higher gain antenna. The 3GPP based modem may operate effectively and efficiency either terrestrially or non-terrestrially based on coverage and availability. This further solves issues regarding multi-path device coverage and bandwidth availability in remote/rural areas.

For example, the D2D may refer to a communication technology that enables devices to communicate directly with each other without the need for an intermediary network infrastructure. In the context of satellite communication, the D2D may refers to the ability of a device, such as a mobile phone or another wireless device, to establish a direct communication link with a satellite without relying on ground-based infrastructure such as cell towers. This direct connectivity provides several advantages, including lower latency, increased mobility support, and simplified infrastructure requirements. The technology is well-suited for applications in remote or underserved areas where traditional network coverage is limited. In the satellite context, D2D systems often leverage satellites in the LEO for reduced latency compared to geostationary satellites. Additionally, D2D technology can be versatile, finding applications in emergency communications, remote sensing, and scenarios where traditional network infrastructure is impractical. It is important to note that the term “Direct-to-Device (D2D)” may also be used in other contexts beyond satellite communication, encompassing technologies that enable direct communication between nearby devices in various wireless networking scenarios.

The outdoor device 104/106 may be equipped with the second antenna unit 118 such as an integrated directional device-to-device (D2D) antenna 306, an integrated VSAT modem 304 (radio frequency (RF) front end), and the first antenna unit 114 such as a separate VSAT antenna 308 for enhanced flexibility and performance. The outdoor device 104/106 may further includes the multi-path radio modem 108 including the processor 202, and the memory 204. The memory may include the modules 206 for optimizing data streams from both orbits associated with the GEO and the LEO. The antenna unit 118 includes a unified antenna to connect to at least one of the first wireless network connection equipment and the second wireless network connection equipment within a frequency band. The antenna unit 118 may establish at least one of a first wireless network mode of communication, and a second wireless network mode of communication. For example, the first wireless network mode of communication may include a geosynchronous Earth orbit (GEO) network and a low Earth orbit (LEO) network-based communication mode. Further, the second wireless network mode of communication may include the GEO network and a non-terrestrial based heterogenous cellular network based communication mode.

For example, the system 300 may cater to global coverage needs, particularly addressing rural markets beyond the reach of conventional cellular networks. The cellular networks may operate within the non-terrestrial environment and may not be associated with satellite orbits. Cellular networks, such as non-terrestrial based 4G Long-Term Evolution (LTE), a non-terrestrial based fifth generation (5G), and a non-terrestrial based sixth generation (6G) primarily use ground-based infrastructure such as cell towers and base stations. However, satellite communication plays a role in extending connectivity to areas with limited terrestrial infrastructure. In this context, satellites can be in different orbits, including the GEO or the LEO, depending on the specific satellite system.

The system 300 may include a single dual-orbit capability, by establish communication links with satellites in both GEO and LEO, ensuring robust connectivity and enhanced performance. The multi-path radio modem 108 may combines data streams from both GEO and LEO orbits, ensuring optimal utilization of available resources and maximizing overall system efficiency.

In an example, the outdoor device 104/106 may be communicatively coupled to the indoor device 102 such as an in-home wireless fidelity (Wi-Fi) router utilizing a single radio guide (RG6) cable for data transmission, incorporating the multimedia over coax alliance (MoCA) communication protocol. Additionally, the integrated DC power supply enhances operational reliability and efficiency.

### Exemplary Scenario 1

In an example, the GEO satellites are often used for backhauling connectivity in cellular networks. The GEO satellite serve as a means to connect cellular base stations to the core network infrastructure. This is particularly valuable in remote or underserved areas where laying fiber-optic cables may be impractical. Further, the GEO satellites may provide wide-area coverage, enabling the GEO satellite suitable for reaching remote or sparsely populated regions where terrestrial infrastructure is limited. Cellular operators can extend their network coverage using GEO satellites to reach a broader audience.

In cases of natural disasters or emergencies, cellular networks may experience disruptions. GEO satellites can be crucial in providing temporary or backup connectivity to ensure communication remains available. Further, cellular networks may not have extensive coverage in rural or remote areas. GEO satellites help bridge this gap, enabling cellular operators to extend their services to these regions. Additionally, in regions where traditional terrestrial backhaul solutions are challenging to deploy, satellite connectivity, including GEO satellites, can serve as a viable option for mobile backhaul. This is particularly relevant in developing regions or areas with difficult terrain. The cellular networks support internet of things (IoT) devices in urban and suburban areas, while GEO satellites can extend IoT connectivity to more remote locations. This combination ensures a broader reach for IoT applications. For mobile users traveling to different countries, GEO satellites play a role in providing global roaming support. This connectivity ensures that users can stay connected even when outside the coverage area of their home cellular network.

### Exemplary Scenario 2

In an exemplary scenario, consider enhancements to the 3GPP Non-Terrestrial Network (NTN) based system specifications to increase the bit rate for a hybrid internet service. The system 100 may combine aspects such as the link budget and overall system capacity. The existing D2D service, defined in 3GPP Release 17, aims to connect to handheld devices. However, the data rates supported are dependent on the satellite's capabilities, and with current geosynchronous satellites, the data rates are limited. In Release 17, Narrowband Radio may be proposed for the LEO satellites, providing higher data rates than geosynchronous satellites. This service may be used for cell phones, acknowledging their limited antenna capability. The system 100 and 300 may include the antenna unit 114/118/306 to harness the capabilities of the 3GPP NTN specification, reducing latency on LEO to mobile device paths. While terrestrial head-and-hand effects degrade antenna gain by several dB in typical handheld devices, the fixed, omnidirectional antenna employed in the present disclosure may provide some advantages. Consequently, D2D NTN satellite systems utilizing the techniques in the present disclosure may experience a minimal impact on capacity per Mbyte transmitted, compared to systems using handheld phones. This may allow for seamless integration of multi-WAN operation within D2D NTN satellite systems without sacrificing significant system capacity. Alternatively, safety concerns related to the human body may be less relevant, as the human body may not be relevant to a handheld device, and there may be an opportunity to design and integrate a higher gain, more directional antenna unit. This, in turn, may enhance the throughput of the modem and improve the overall system efficiency in terms of bits per Hz.

Consider a versatile antenna system that can connect to both satellites and terrestrial cell towers. The same device, utilizing the same antenna design and operating in the same frequency band, can be strategically positioned for connectivity in areas with or without terrestrial cellular coverage. The device could be placed in Position A, where the antenna connects to a normal cell tower, and the antenna works with the existing cellular network architecture. Conversely, the same device, with the same design, can be deployed in an area lacking cellular connectivity, where it then utilizes connections over the LEO satellites. In an example, there may be an internal switch or similar mechanism within the device that allows users to change the system's usage. Typically, the device would automatically prioritize terrestrial cellular connections when available. However, there may be scenarios, as mentioned, where utilizing LEO satellites may be beneficial, especially in cases where roaming agreements with terrestrial service providers might incur higher costs. The users might choose between cellular and LEO satellite connections based on factors such as location, service provider agreements, and cost considerations. While the system 100/300 normal operation involves automatic selection based on available connectivity, the possibility of implementing beneficial routing adds an additional layer of adaptability to the device's functionality.

FIG. 4A illustrates a block diagram representation of a network architecture for a system 400A, which includes an integrated multi-path-based geostationary earth orbit (GEO) outdoor device (e.g., second outdoor device 106) and/or cellular network-based outdoor device (e.g., first outdoor device 104), according to an example. The system 400A integrates an outdoor device capable of multi-path-based communication through the GEO and cellular networks. The system 400A includes the indoor device 102, the outdoor device 104/106. The outdoor device 104/106 may include a cellular modem 402 (e.g., a non-terrestrial based 4G, 5G, 6G, NR, and the like), a cellular antenna 404, the multi-path radio modem 108, and a VSAT modem 406 communicatively coupled to a VSAT antenna 408.

The outdoor device 104/106 may include a combined multi-path radio serving as a principal component, facilitating multi-path-based communication. The outdoor device 104/106 may combine data streams from various sources, optimizing network performance, and ensuring efficient utilization of available communication paths. Further, the VSAT modem 406 may be integrated into the outdoor device 104/106, providing a reliable communication link via a very small aperture terminal (VSAT) communication protocol. The VSAT modem 406 may optimize the reception and transmission of signals, enhancing data throughput and reliability through GEO satellite communication.

The cellular modem 402 may be for example, a 4G/5G modem (or 6G modem) configured to communication over cellular networks, providing high-speed mobile broadband connectivity. For example, the cellular modem 402 may supports the latest 4G, 5G, and 6G standards, ensuring compatibility with modern cellular networks. Additionally, the multi-path radio modem 108 may manage and combine data streams from both the cellular modem 402 and the VSAT modem 406, optimizing the overall network performance and ensuring a seamless user experience. Further, the cellular antenna unit 404 may transmit and receive signals over cellular networks (e.g., utilizing 600 MHz-900 MHz and 1.5+GHz). The cellular antenna unit 404 may be optimized for high data transfer rates and ensures a robust connection to, for example, 4G, 5G, and 6G networks.

For example, the outdoor device 104/106 utilizes a single coaxial cable (MoCA) for connectivity, streamlining the installation process. This single coaxial cable serves as the conduit for data transmission between the outdoor device 104/106 and the indoor device 102. The system 400A may include versatile applications including, but is not limited to, rural connectivity, remote communication, and areas where a hybrid approach utilizing both GEO satellite and cellular networks may be beneficial.

### Exemplary Scenario 3

Consider, using multiple paths and transports to create a unified internet service. Combining satellite and cellular networks, where cellular network provides a low-latency path, and the GEO satellites provide a high bandwidth with high latency. To address latency concerns, consider integrating Direct-to-Device technology, particularly in LEO constellations, known for low latency. The key advantage may include the ability to connect standard mobile devices directly to satellites, eliminating the need for proprietary systems. The current Direct-to-Device (D2D) systems are designed for low-bit-rate applications, such as short message services (SMS) or low-resolution video and proposes enhancements to increase the bit rate. This enhancement aims to enable the D2D technology viable for a hybrid internet service, optimizing multi-path combinations and expanding the capabilities beyond low-bit-rate applications.

FIG. 4B illustrates a block diagram representation of a network architecture for a system 400B, which includes a geostationary earth orbit (GEO) outdoor device (e.g., second outdoor device 106) and/or cellular network-based outdoor device (e.g., first outdoor device 104) connected using a multimedia over coax alliance (MoCA) connection protocol, according to an example. The system 400B includes the indoor device 102, the first outdoor device 104 and the second outdoor device 106. The first outdoor device 104 may include a cellular modem 412 (e.g., a non-terrestrial based 4G, 5G, 6G, NR, and the like), a cellular antenna 414, and the multi-path radio modem 108. Further, the second outdoor device 106 may include a VSAT modem 416 communicatively coupled to a VSAT antenna 418.

The system 400B may include a hybrid communication approach, incorporating both GEO satellite and cellular communication protocols. The system 400B may utilize the MoCA for data transfer, and DC power distribution between the first outdoor device 104 and the second outdoor device 106, and between the indoor device 102 and the first outdoor device 104, creating a shared network for enhanced connectivity.

The outdoor devices 104/106 in the system 400B may provide cellular communication along with an integrated antenna such as a cellular antenna unit 414. The multi-path radio modem 108 may manage multi-path communication. The system 400B may include a dedicated satellite modem such as a VSAT modem 416 to establish a reliable communication link with GEO satellites. This modem ensures efficient data transfer over satellite networks. The VSAT antenna 418 may be optimized for GEO satellite communication, providing a robust link between the second outdoor device 106 and the GEO satellite constellation.

The indoor device 102 in the system 400B may be a wireless fidelity (Wi-Fi) router that may be included to create a local wireless network. The indoor device 102 may serve as the central hub for connecting various devices within the indoor environment, providing access to a shared network.

In nan example, the MoCA communication protocol may be implemented for communication between the first outdoor device 104 and the second outdoor device 106, and between the indoor device 102 and the first outdoor device 104 in the system 400B. The MoCA facilitates high-speed data transfer over existing coaxial cables. The MoCA network may also serve as a conduit for DC power distribution between the first outdoor device 104 and the second outdoor device 106, and between the indoor device 102 and the first outdoor device 104. The shared network approach simplifies cabling infrastructure and ensures a unified power distribution system. The system 400B may be provide global coverage, ensuring reliable communication in diverse geographical locations. The combination of cellular and GEO satellite technologies enables connectivity in both urban and remote areas with limited cellular infrastructure and the need for satellite connectivity.

FIG. 4C illustrates a block diagram representation of a network architecture for a system 400C (i.e., (a) of FIG. 4C), which includes a geostationary earth orbit (GEO) outdoor device (e.g., second outdoor device 106) and/or cellular network-based outdoor device (e.g., first outdoor device 104) connected using a multimedia over coax alliance (MoCA) connection protocol, and an interconnect facility link (IFL) connection protocol (i.e., (b) of FIG. 4C) comprising a single coaxial cable, according to an example. The system 400C, includes the indoor device 102, the first outdoor device 104, and the second outdoor device 106. The indoor device 102 may include a Wi-Fi 6 router 430, and a VSAT modem 426. Further, the first outdoor device 104 may include a cellular modem 422, and the multi-path radio modem 108. Furthermore, the second outdoor device may include a VSAT RF 424 front end, communicatively coupled to a VSAT antenna unit 428.

The connectivity between the first outdoor device 104 and the second outdoor device 106 may be established through the interconnect facility link (IFL) connection protocol and powered by DC power. Further, the connectivity between the indoor device 102 and the first outdoor device 104 may be established through the MoCA connection protocol, supported by IFL connection protocol, ingeniously facilitated by a single coaxial cable. Additionally, the integrated DC power supply enhances operational reliability and efficiency. In an example, each signal from the DC power, the MoCA connection protocol, and a satellite-based IFL may be appropriately filtered at the receiving outdoor units (e.g., any of the first outdoor device 104, the second outdoor device 106 and/or the multi-path radio modem 108) to ensure effective separation of signals before being utilized by one or more outdoor units.

The system 400C integrates communication technologies, incorporating both GEO satellite and cellular networks. The GEO outdoor device (second outdoor device 106) ensures robust connectivity via satellite, while the cellular network-based outdoor device (first outdoor device 104) provides cellular communication for versatile connectivity options. The single coaxial cable acts as a conduit for multiple protocols. For example, single RG6 cable efficiently carries MoCA data, IFL signals, and DC power. The streamlined approach simplifies cabling infrastructure, optimizing installation, and enhancing system efficiency. Further, the MoCA connection protocol facilitates communication between the indoor device 102 and the multi-path radio modem 108 via the first outdoor device 104. This protocol ensures efficient data transfer within the indoor environment, enabling a high-speed and reliable connection.

Additionally, the IFL connection protocol manages communication between the indoor device 102 and the second outdoor device 106. The protocol, facilitated by the single coaxial cable, contributes to the unified and efficient data exchange within the system. The indoor device 102 may serve as a central hub within the architecture, hosting Wi-Fi capabilities and a satellite modem such as the VSAT modem 426. The first outdoor device 104 may incorporate cellular communication capabilities along with an integrated antenna. The optional built-in coax splitter enhances flexibility in configuring the system. Additionally, a satellite radio and RF component such as the VSAT RF 424, along with a dedicated satellite antenna such as the VSAT antenna 428 may contribute to the comprehensive functionality of the second outdoor device 106.

In an example, in the system 400C may perform MoCA and the IFL multiplexing as shown in (b) of FIG. 4C. The MoCA may be a standard for multimedia networking over coaxial cables. MoCA allows the transmission of high-speed data, including video and audio, over existing coaxial cable infrastructure. Further, simultaneous transmission of MoCA signals and other communication protocols over a single IFL, based on multiplexing allows for the efficient use of a shared communication medium. The DC may be used for providing power to devices and components within the network. Further, a digital satellite equipment control (DiSEqC) may be a communication protocol used in satellite communication systems. The DiSEqC allows for the control of satellite receiving equipment, such as satellite dishes, and enables features such as dish positioning and switching between different satellites. The MoCA and IFL multiplexing may be based on pulse width modulation (PWM), where the width of pulses in a pulse train is varied to convey information. In communication systems, PWM may be used for tasks such as controlling the intensity of signals or as part of a modulation scheme. Additionally, a transmit reference (Tx ref) may refers to a reference signal used in the transmitting process. For example, a signal that serves as a reference for calibration or synchronization purposes.

Further, a MoCA band E, where ‘band E’ Band E (e.g., 400 MHZ-650 MHz), may refers to a specific frequency band allocated for MoCA communication, may include a plurality of MoCA bands operated in different frequency ranges to avoid interference with other services. The receiver (RX) may refer to the component that receives signals in a communication system. For example, Rx may be used for reception of MoCA signals or other communication signals. Further, transmitter (Tx) may refer to the component that sends signals in a communication system. For example, the Tx may be used for transmission of MoCA signals or other communication signals.

### Exemplary Scenario 4

Consider a scenario of incorporates both a Wi-Fi router and a GEO satellite modem. The GEO satellite modem communicates with an outdoor unit using the IFL connection protocol. The IFL operates in the frequency range of 1 gigahertz to 2 gigahertz for downlink and 500 megahertz or less for uplink. The IFL links the indoor unit to the outdoor unit, handling up and down conversion, amplification, and filtering to communicate over the satellite. Further, the cellular terrestrial modem may be the outdoor component. However, the challenge arises because the cellular terrestrial modem may not communicate over the IFL link. To address this, the MoCA may be introduced as a mechanism for the indoor side to communicate with the outdoor unit. The MoCA operates at different frequencies, requiring careful selection to coexist with the existing signals on the same coaxial cable. The use of frequency division multiplexing (FDMA) may combine MoCA, IFL, and DC on a single cable. In an example, a single modem may be used for terrestrial connections and connect to LEO satellites, adding flexibility to the system 100/400C.

FIG. 4D illustrates a block diagram representation of a network architecture for a system 400D, which includes a geostationary earth orbit (GEO) outdoor device (e.g., second outdoor device 106) and/or cellular network-based outdoor device (e.g., first outdoor device 104) connected using the MoCA connection protocol and the IFL connection protocol comprising a dual coaxial cable, according to an example. The system 400D, includes the indoor device 102, the first outdoor device 104, and the second outdoor device 106. The indoor device 102 may include a Wi-Fi 6 router 440, and a VSAT modem 436. Further, the first outdoor device 104 may include a cellular modem 432, and the multi-path radio modem 108. Furthermore, the second outdoor device may include a VSAT RF 434 front end, communicatively coupled to a VSAT antenna unit 438. The connectivity between the indoor device 102 and the first outdoor device 104 may be established through the MoCA connection protocol. Additionally, the integrated DC power supply enhances operational reliability and efficiency. Further, the connectivity between the indoor device 102 and the second outdoor device 106 outdoor devices may be established through the interconnect facility link (IFL) connection protocol and powered by DC power.

The system 400D includes implements an integration of communication technologies, combining both GEO satellite and cellular networks. The GEO outdoor device such as the second outdoor device 106 may ensure robust connectivity via satellite, while the cellular network-based outdoor device such as the first outdoor device 104 may provide cellular communication for versatile connectivity options. Unlike the single coaxial cable in previous architectures, the system 400D employs a dual coaxial cable configuration. Two RG6 cables are utilized for distinct purposes. For example, the MoCA to first outdoor device 104 may use one RG6 cable that facilitates the MoCA connection protocol, efficiently carrying data between the indoor device 102 and the first outdoor device 104. Another connection may include the IFL to satellite amplifier/RF. The second RG6 cable may be dedicated to the IFL connection protocol, managing the communication between the indoor device 102 and the satellite amplifier/RF component such as the VSAT RF 434 front end.

The indoor device 102 may serves as a central hub within the architecture, hosting both Wi-Fi capabilities and a satellite modem. The indoor device 102 may integrate with the MoCA protocol for communication, ensuring a robust connection to both the GEO and cellular outdoor devices. The outdoor components incorporate cellular communication capabilities along with MoCA support. Additionally, the outdoor system features a dedicated Satellite amplifier/RF component and a satellite antenna, contributing to the outdoor devices' comprehensive functionality.

FIG. 5A illustrates a block diagram representation of a network architecture for a system 500A, which includes a geostationary earth orbit (GEO) outdoor device (e.g., second outdoor device 106) and a low earth orbit (LEO) outdoor device (e.g., first outdoor device 104) (i.e., two outdoor devices) connected using a multimedia over coax alliance (MoCA) connection protocol, according to an example. The system 500A may include the indoor device 102, the first outdoor device 104, and the second outdoor device 106. The indoor device 102 may include a Wi-Fi 6 router 510, and multi-path radio modem 108. Further, the first outdoor device 104 may include a LEO modem 502, and a phased array antenna 504. Furthermore, the second outdoor device may include a VSAT modem 506, communicatively coupled to a VSAT antenna unit 508. The connectivity between the indoor device 102 and the first outdoor device 104 may be established through a MoCA connection protocol via a splitter 512. Additionally, a second integrated DC power supply enhances operational reliability and efficiency between the indoor device 102 and the first outdoor device 104. Further, the connectivity between the indoor device 102 and the second outdoor device 106 outdoor devices may be established through the MoCA connection protocol and powered by DC power via the splitter 512.

The system 500A may include a dual-outdoor device configuration. The connectivity between these outdoor devices is established through the MoCA connection protocol. The system 500A may include both GEO satellite and LEO satellite networks. The GEO outdoor device (second outdoor device 106) ensures connectivity via GEO satellites, while the LEO outdoor device (first outdoor device 104) ensures LEO satellite communication, which may be adaptable to multiple orbits.

The outdoor modems of both the GEO and LEO devices share a common MoCA network. This shared network facilitates efficient and seamless communication between the outdoor devices, for interoperability and effective data transfer. The additional RG6 for DC power to first outdoor device 104, in which an extra RG6 coaxial cable serves a dual purpose. While the RG6 supplies additional DC power to the outdoor device, the RG6 also contributes to the overall power distribution within the system.

### Exemplary Scenario 5

Consider a scenario of placing a specialized antenna inside an overall router device alongside a satellite GEO modem. The terminal device may integrate both LEO and GEO satellite modems. The combining algorithm in the multi-path radio modem 108 may performing deep packet inspection, especially on user traffic. Based on the properties of the available transports, the software determines the optimal path or transport for each specific packet. The GEO modem and the LEO modem includes a high-gain antenna with combined components in the same modem/terminal. The transition from a terrestrial combining function to LEO and GEO combination within a single terminal device require thorough verification and testing.

FIG. 5B illustrates a block diagram representation of a network architecture for a system, which includes a geostationary earth orbit (GEO) outdoor device (e.g., second outdoor device 106), a low earth orbit (LEO) outdoor device (e.g., second outdoor device 106), and the multi-path radio modem 108 (i.e., three outdoor devices) connected using a multimedia over coax alliance (MoCA) connection protocol, according to an example.

The system 500B may include the indoor device 102, the first outdoor device 104, the second outdoor device 106, and the multi-path outdoor modem 108. The indoor device 102 may include a Wi-Fi 6 router 520. Further, the first outdoor device 104 may include a LEO modem 522, and a phased array antenna 524. Furthermore, the second outdoor device 106 may include a VSAT modem 526, communicatively coupled to a VSAT antenna unit 528. The connectivity between the indoor device 102 and the multi-path radio modem 108 may be established through a MoCA connection protocol. Additionally, an integrated DC power supply enhances operational reliability and efficiency between the indoor device 102 and the multi-path radio modem 108. Further, the connectivity between the first outdoor device 104 and the multi-path radio modem 108 may be established through the MoCA connection protocol and powered by DC power. Further, the connectivity between the second outdoor device 106 and the multi-path radio modem 108 may be established through the MoCA connection protocol and powered by DC power. Additionally, a second DC power may be provided from the indoor device 102 to the first outdoor device 104.

The system 500B may implement both GEO satellite and LEO satellite networks. The GEO outdoor device (second outdoor device 106), the LEO outdoor device (second outdoor device 106), and the multi-path radio modem 108 collectively form a comprehensive network, providing adaptability to multiple satellite orbits. The three outdoor devices, including GEO, LEO, and the multi-path radio modem 108, share a plurality of MoCA network. The indoor device 102, the first outdoor device 104, the multi-path radio modem 108, and the second outdoor device 106 may share single MoCA network. The shared MoCA network provides seamless communication between the outdoor devices, promoting interoperability and effective data transfer.

The system 500B may include a three-way splitter, which can either be built into the multi-path radio modem 108 or implemented as a separate component. The three-way splitter may divide the MoCA network signals to ensure effective communication across all three outdoor devices. An extra RG6 coaxial cable serves a dual purpose, supplying additional DC power specifically to the first outdoor device 104.

Although, the devices 102, 104, 106, 108 are described as being implemented through SDR techniques and/or fusion/combing multi-path radio techniques, this is only one example. The devices 102, 104, 106, 108 may optionally be implemented without SDR techniques and/or fusion/combing multi-path radio techniques.

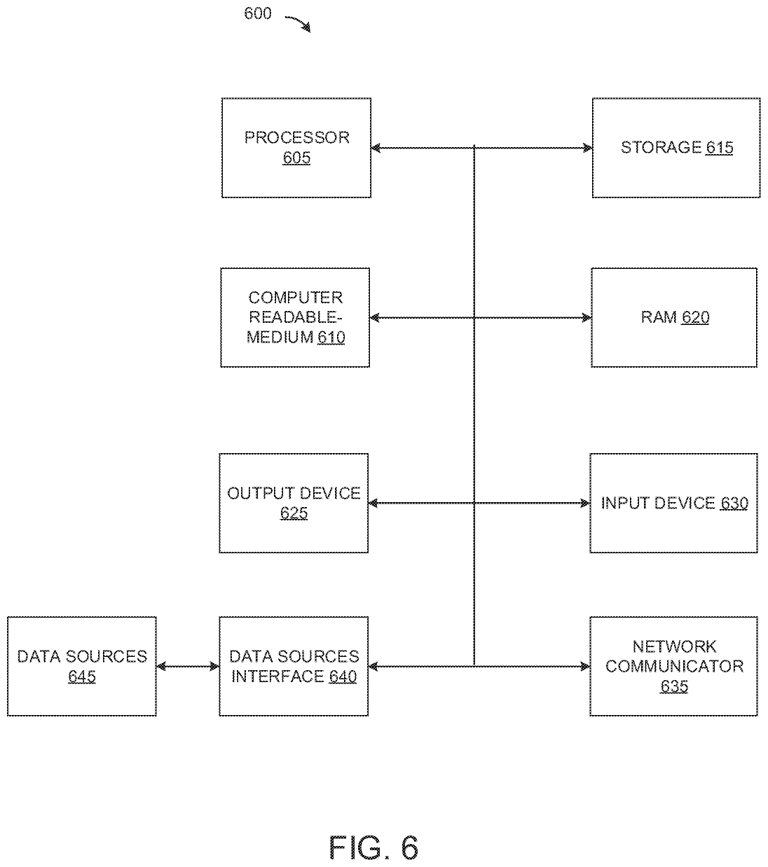

FIG. 6 illustrates a block diagram representation of a hardware platform for implementation of a computer system 600, according to an example. The computer system 600 may be part of or any one of the indoor device 102, the first outdoor device 104, the second outdoor device 106, the multi-path radio modem 108, as shown in the system 100, to perform the functions and features described herein.

For the sake of brevity, construction, and operational features of the system 100 which are explained in detail above are not explained in detail herein. Particularly, computing machines such as but not limited to internal/external server clusters, quantum computers, desktops, laptops, smartphones, tablets, and wearables which may be used to execute the system 100 or may have the structure of the hardware platform 600. As illustrated, the hardware platform 600 may include additional components not shown, and that some of the components described may be removed and/or modified. For example, a computer system with multiple graphics processing unit (GPUs) may be located on external-cloud platforms including web services, or internal corporate cloud computing clusters, or organizational computing resources, and the like.

The hardware platform 600 may be a computer system such as the system 100 that may be used with the embodiments described herein. The computer system may represent a computational platform that includes components that may be in a server or another computer system. The computer system may execute, by the processor 605 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 605 that executes software instructions or code stored on a non-transitory computer-readable storage medium 610 to perform methods of the present disclosure.

The instructions on the computer-readable storage medium 610 are read and stored the instructions in storage 615 or in random access memory (RAM). The storage 615 may provide a space for keeping static data where at least some instructions could be stored for later execution. The stored instructions may be further compiled to generate other representations of the instructions and dynamically stored in the RAM such as RAM 620. The processor 605 may read instructions from the RAM 620 and perform actions as instructed.

The computer system may further include the output device 625 to provide at least some of the results of the execution as output including, but not limited to, visual information to users, such as external agents. The output device 625 may include a display on computing devices and virtual reality glasses. For example, the display may be a mobile phone screen or a laptop screen. Graphical user interfaces (GUIs) and/or text may be presented as an output on the display screen. The computer system may further include an input device 630 to provide a user or another device with mechanisms for entering data and/or otherwise interact with the computer system. The input device 630 may include, for example, a keyboard, a keypad, a mouse, or a touchscreen. Each of these output devices 625 and input device 630 may be joined by one or more additional peripherals. For example, the output device 625 may be used to display the results.

A network communicator 635 may be provided to connect the computer system to a network and in turn to other devices connected to the network including other clients, servers, data stores, and interfaces, for instance. A network communicator 635 may include, for example, a network adapter such as a LAN adapter or a wireless adapter. The computer system may include a data sources interface 640 to access the data source 645. The data source 645 may be an information resource. As an example, a database of exceptions and rules may be provided as the data source 645. Moreover, knowledge repositories and curated data may be other examples of the data source 645.

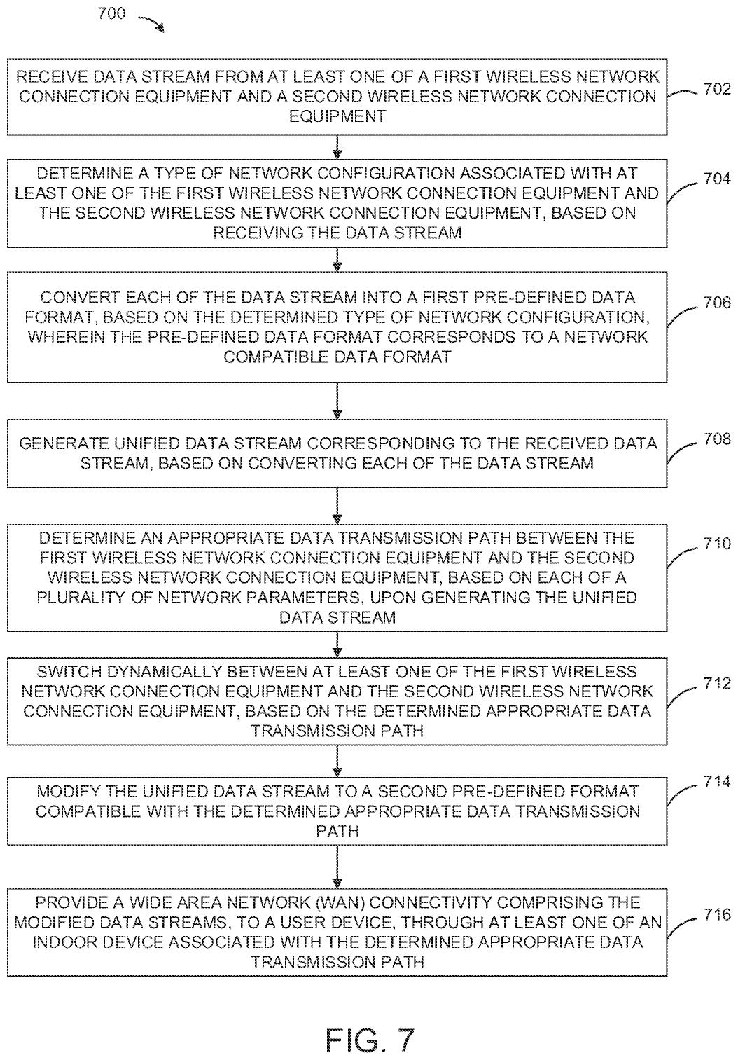

FIG. 7 illustrates a flow diagram representation of a method 700 of integrating multi-orbit and multi-path network to provide a unified wide area network (WAN) connectivity for user devices 110, according to an example. The disclosed method may be performed by one or more components of the systems (100, 108, 300, 400A, 400B, 400C, 400D, 500A, and 500B) disclosed herein. For example, with reference to FIG. 2, the steps disclosed herein may be performed by the processor 202. In yet another example, some of the steps disclosed herein may be performed by the Wi-Fi 6 router.

At block 702, the method 700 may include receiving, by the processor 202, data stream from at least one of a first wireless network connection equipment and a second wireless network connection equipment. The first wireless network connection equipment comprises a satellite-based multi-path transport protocol. The second wireless network connection equipment comprises a non-terrestrial-based multi-path transport protocol and the satellite-based multi-path transport protocol.

At block 704, the method 700 may include determining, by the processor 202, a type of network configuration associated with at least one of the first wireless network connection equipment and the second wireless network connection equipment, based on receiving the data stream.

At block 706, the method 700 may include converting, by the processor 202, each of the data stream into a first pre-defined data format, based on the determined type of network configuration. The first pre-defined data format corresponds to a network compatible data format.

At block 708, the method 700 may include generating, by the processor 202, unified data stream corresponding to the received data stream, based on converting each of the data stream.

At block 710, the method 700 may include determining, by the processor 202, an appropriate data transmission path between the first wireless network connection equipment and the second wireless network connection equipment, based on each of a plurality of network parameters, upon generating the unified data stream.

At block 712, the method 700 may include switching, by the processor 202, dynamically between at least one of the first wireless network connection equipment and the second wireless network connection equipment, based on the determined appropriate data transmission path.

At block 714, the method 700 may include modifying, by the processor 202, the unified data stream to a second pre-defined data format compatible with the determined appropriate data transmission path. The second pre-defined data format corresponds to at least one of a non-terrestrial-based multi-path transport protocol format and a satellite-based multi-path transport protocol format.

At block 716, the method 700 may include providing, by the processor 202, a wide area network (WAN) connectivity comprising the modified data streams, to the user device 110, through at least one of the indoor device 102 associated with the determined appropriate data transmission path. The first wireless network connection equipment includes the indoor device 102, and the first outdoor device 104. The second wireless network connection equipment includes the indoor device 102, and the second outdoor device 106.

The order in which the method 700 is described is not intended to be construed as a limitation, and any number of the described method blocks may be combined or otherwise performed in any order to implement the method 700 or an alternate method. Additionally, individual blocks may be deleted from the method 700 without departing from the spirit and scope of the ongoing description. Furthermore, the method 700 may be implemented in any suitable hardware, software, firmware, or a combination thereof, that exists in the related art or that is later developed. The method 700 describes, without limitation, the implementation of the systems (100, 108, 300, 400A, 400B, 400C, 400D, 500A, and 500B). A person of skill in the art will understand that method 700 may be modified appropriately for implementation in various manners without departing from the scope and spirit of the ongoing description.

Various examples of the system and methods for integrating multi-orbit and multi-path networks to provide a unified wide area network (WAN) connectivity for user devices, based on combining data streams from satellite orbits and cellular networks, may be provided. The system and methods provide a hybrid multi-path deployment architecture in various satellite communication systems. The systems and methods provide multi-path deployments combining two or more data transports, typically wireless, to create a unified and perceived single user data service. The system and methods address the limitations of high bandwidth geosynchronous orbit (GEO) satellite systems, which, while effective in delivering high-speed data over a large area, suffer from a minimum packet round-trip time (RTT) of at least, for example, 480 milli-seconds (ms). The introduction of Direct to Device (D2D) service providers using Low Earth Orbit (LEO) satellite systems enable combining the primary high-bandwidth GEO path with a low-latency and appropriate auxiliary path. The systems and methods may combine the latency sensitive packets from the non-terrestrial wireless link such as the GEO and the latency insensitive packets from the non-terrestrial wireless link such as the LEO. This provides a low-latency connectivity in remote or geographically challenging locations to reach and provide effectiveness of combining techniques in such areas.

The systems and methods enhance 3GPP non-terrestrial network (NTN)-based D2D systems, aiming to improve the link budget and overall system capacity. Using the cellular 3GPP technology, D2D modem chipsets benefit from market volumes, addressing the downside of limited capacity per beam in Frequency Range 1 (FR1) D2D New Radio (NR) systems. To further enhance the capabilities of LEO D2D satellites, the systems and method provides fixed terminal types supporting directional stub/helical antennas, resulting in increased antenna gain. By incorporating software defined radio (SDR) techniques, the dynamic range may be enhanced, allowing concurrent support for D2D operation and higher-capacity fixed operation. This enhancement in gain may provide higher-order modulation, significantly improving available capacity.

The NTN D2D antenna may be a fixed, high-gain antenna which may be optimized for the LEO satellite communication with enhanced signal reception and transmission capabilities. The NTN D2D may determine appropriate network path (terrestrial or satellite) based on real-time network parameters such as a signal strength, a bandwidth availability, and a latency. The fixed, high-gain antenna provides significant performance advantages over D2D smartphone devices when connected to a LEO satellite, including improved signal strength, by optimizing antenna design and fixed, clear-sky positioning. Further, fixed, high-gain antenna may provide enhanced data transfer rates, by facilitating a higher gain and lower signal attenuation, and reduced power and bandwidth consumption, by minimizing impact on LEO satellite capacity per megabyte transmitted.

Further, the systems and methods incorporate non-terrestrial satellite links, for the multi-orbit and the multi-path architecture. The integration of multiple wireless technologies, specifically satellite technology such as interconnect facility link (IFL) and multimedia over coax alliance (MoCA), onto the same RG6 cable introduces challenges that are effectively addressed in the proposed systems and methods. The challenges are addressed by filtering each of the IFL, the MoCA, and the DC power at the receiving end of one or more outdoor units. The MoCA may be utilized for its ease of installation, robustness, and constructive collaboration with existing coax RG6 cable architectures, providing a seamless integration process. The choice of MoCA channel frequencies, particularly in Band E (e.g., 400 MHz-650 MHZ), may be a key consideration. The band E may be identified for stable operation, providing sufficient spectrum to achieve high throughput on the MoCA link, meeting for example, one Gigabyte per second (1 Gbps) requirement. To exceed the 1 Gbps throughput, the systems and methods necessitates a mechanism for coordinated band operation between MoCA, cellular networks (utilizing 600 MHz-900 MHz and 1.5+GHz), and satellite communication. The coordination ensures appropriate use of available spectrum and prevents interference, maintaining the integrity of the communication channels.

One of ordinary skill in the art will appreciate that techniques consistent with the ongoing description are applicable in other contexts as well without departing from the scope of the ongoing description.

As mentioned above, what is shown and described with respect to the systems and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing handoff.

It should also be appreciated that the systems and methods, as described herein, may also include, or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

Although examples are directed to satellite communication systems, such as GEO and LEO systems, it should be appreciated that the systems and methods described herein may also be used in other various systems and other implementations. For example, these may include other various telecommunication test and measurement systems. In fact, there may be numerous applications in cable or optical communication networks, not to mention fiber sensor systems that could employ the systems and methods as well.

What has been described and illustrated herein are examples of the implementation along with some variations. The terms, descriptions, and figures used herein are set forth by way of illustration only and are not meant as limitations. Many variations are possible within the scope of the implementations, which is intended to be defined by the following claims—and their equivalents—in which all terms are meant in their broadest reasonable sense unless otherwise indicated.

1. A system comprising:
a first wireless network connection equipment comprising a satellite-based multi-path transport protocol, wherein the first wireless network connection equipment comprises an indoor device, and a first outdoor device;
a second wireless network connection equipment comprising a non-terrestrial-based multi-path transport protocol and the satellite-based multi-path transport protocol, wherein the second wireless network connection equipment comprises the indoor device, and a second outdoor device;
wherein at least one of the indoor device, the first outdoor device, and the second outdoor device is communicatively coupled to a multi-path radio modem; and
wherein the multi-path radio modem comprises:
a processor; and
a memory coupled to the processor, wherein the memory comprises processor-executable instructions, which on execution, cause the processor to:
receive a data stream from at least one of the first wireless network connection equipment and the second wireless network connection equipment;
determine a type of network configuration associated with at least one of the first wireless network connection equipment and the second wireless network connection equipment, based on receiving the data stream;
convert each data stream into a first pre-defined data format, based on the determined type of network configuration, wherein the first pre-defined data format corresponds to a network compatible data format;
generate a unified data stream corresponding to the received data stream, based on converting each of the data stream;
determine an appropriate data transmission path between the first wireless network connection equipment and the second wireless network connection equipment, based on each of a plurality of network parameters, upon generating the unified data stream;
switch dynamically between at least one of the first wireless network connection equipment and the second wireless network connection equipment, based on the determined appropriate data transmission path;
modify the unified data stream to a second pre-defined data format compatible with the determined appropriate data transmission path, wherein the second pre-defined data format corresponds to at least one of a non-terrestrial-based multi-path transport protocol format and a satellite-based multi-path transport protocol format; and
provide a wide area network (WAN) connectivity comprising the modified data streams, to a user device, through the indoor device associated with the determined appropriate data transmission path.

2. The system of claim 1, wherein, for determining the appropriate data transmission path between the first wireless network connection equipment and the second wireless network connection equipment, based on each of the plurality of network parameters, the processor is to:
determine a quality of service (QOS) required for a user traffic associated with the generated unified data stream;
classify the user traffic associated with the generated unified data stream, based on determining the quality of service (QOS); and
determine at least one of a latency parameter and a bandwidth parameter associated with the first wireless network connection equipment and the second wireless network connection equipment, upon classifying the user traffic.

3. The system of claim 1, wherein the first wireless network connection equipment comprises at least one of a Geosynchronous Earth Orbit (GEO) modem, and a Direct to Device (D2D) Low Earth Orbit (LEO) modem integrated into the first outdoor device.

4. The system of claim 3, wherein the D2D LEO modem comprises a non-terrestrial network (NTN) Device-to-Device (D2D) antenna unit for a LEO satellite communication, wherein the NTN D2D antenna unit is to:
connect, via a multi-WAN access module, to at least one of a terrestrial cellular network and a LEO satellite network based on a location and available network conditions;
communicate with the LEO satellite with signal reception and transmission capabilities as a fixed and a high-gain antenna; and
determine an appropriate network path between a terrestrial path and a satellite path, based on real-time network parameters comprising at least one of a signal strength, a bandwidth availability, and a latency.

5. The system of claim 3, wherein the D2D LEO modem is to establish an auxiliary path associated with the first wireless network connection equipment, for transmitting the unified data stream, wherein the unified data stream associated with the GEO and the D2D LEO modem comprises latency-sensitive Internet Protocol (IP) packets associated with the satellite-based multi-path transport protocol.

6. The system of claim 1, wherein the second wireless network connection equipment comprises a Geosynchronous Earth Orbit (GEO) modem, and a non-terrestrial based heterogenous cellular modem integrated into at least one of the second outdoor device, and the indoor device, wherein the unified data stream associated with the GEO and the non-terrestrial based heterogenous cellular modem comprises latency-insensitive Internet Protocol (IP) packets associated with the satellite-based multi-path transport protocol.

7. The system of claim 1, wherein the indoor device and the first outdoor device are communicatively coupled using at least one of a coax splitter protocol, a multimedia over coax alliance (MoCA) connection protocol and powered using a Direct Current (DC) power connection protocol between the indoor device and the first outdoor device.

8. The system of claim 1, wherein the indoor device and the second outdoor device are communicatively coupled using at least one of a coax splitter protocol, a multimedia over coax alliance (MoCA) connection protocol, a interconnect facility link (IFL) protocol, and a powered using a Direct Current (DC) power connection protocol between the indoor device and the second outdoor device.

9. The system of claim 8, wherein the MoCA connection protocol and the IFL protocol comprises a plurality of operational configurations and frequency ranges corresponding to at least one of the indoor device, the first outdoor device, and the second outdoor device.

10. The system of claim 1, wherein the first outdoor device and the second outdoor device comprises an antenna unit comprising a unified antenna to connect to at least one of the first wireless network connection equipment and the second wireless network connection equipment within a frequency band, wherein the antenna unit establishes at least one of a first wireless network mode of communication, and a second wireless network mode of communication.

11. The system of claim 1, wherein the plurality of parameters comprise at least one of the classification of the user traffic associated with the generated unified data stream, a latency parameter associated with the first wireless network connection equipment and the second wireless network connection equipment, a bandwidth parameter associated with the first wireless network connection equipment and the second wireless network connection equipment, and a quality of service (QOS) required for the user traffic.

12. A method comprising:
receiving, by a processor, a data stream from at least one of a first wireless network connection equipment and a second wireless network connection equipment, wherein the first wireless network connection equipment comprises a satellite-based multi-path transport protocol, and wherein the second wireless network connection equipment comprises a non-terrestrial-based multi-path transport protocol and the satellite-based multi-path transport protocol;
determining, by the processor, a type of network configuration associated with at least one of the first wireless network connection equipment and the second wireless network connection equipment, based on receiving the data stream;
converting, by the processor, each of the data stream into a first pre-defined data format, based on the determined type of network configuration, wherein the first pre-defined data format corresponds to a network compatible data format;
generating, by the processor, a unified data stream corresponding to the received data stream, based on converting each of the data stream;
determining, by the processor, an appropriate data transmission path between the first wireless network connection equipment and the second wireless network connection equipment, based on each of a plurality of network parameters, upon generating the unified data stream;
switching, by the processor, dynamically between at least one of the first wireless network connection equipment and the second wireless network connection equipment, based on the determined appropriate data transmission path;
modifying, by the processor, the unified data stream to a second pre-defined data format compatible with the determined appropriate data transmission path, wherein the second pre-defined data format corresponds to at least one of a non-terrestrial-based multi-path transport protocol format and a satellite-based multi-path transport protocol format; and
providing, by the processor, a wide area network (WAN) connectivity comprising the modified data streams, to a user device, through at least one of an indoor device associated with the determined appropriate data transmission path, wherein the first wireless network connection equipment comprises the indoor device, and a first outdoor device, and wherein the second wireless network connection equipment comprises the indoor device, and a second outdoor device.

13. The method of claim 12, wherein determining the appropriate data transmission path between the first wireless network connection equipment and the second wireless network connection equipment, based on each of the plurality of network parameters, further comprises:
determining, by the processor, a quality of service (QOS) required for a user traffic associated with the generated unified data stream;
classifying, by the processor, the user traffic associated with the generated unified data stream, based on determining the quality of service (QOS); and
determining, by the processor, at least one of a latency parameter and a bandwidth parameter associated with the first wireless network connection equipment and the second wireless network connection equipment, upon classifying the user traffic.

14. The method of claim 12, further comprises:
establishing, by the processor, via the first wireless network connection equipment, an auxiliary path associated with the first wireless network connection equipment, for transmitting the unified data stream, wherein the unified data stream comprises latency-sensitive Internet Protocol (IP) packets associated with the satellite-based multi-path transport protocol.

15. The method of claim 12, further comprises:
establishing, by the processor, via an antenna unit, at least one of a first wireless network mode of communication, and a second wireless network mode of communication, wherein the first outdoor device and the second outdoor device comprises the antenna unit comprising a unified antenna; and
connecting, by the processor, via the antenna unit, to at least one of the first wireless network connection equipment and the second wireless network connection equipment within a frequency band.

16. The method of claim 12, wherein the plurality of parameters comprises at least one of the classification of the user traffic associated with the generated unified data stream, a latency parameter associated with the first wireless network connection equipment and the second wireless network connection equipment, a bandwidth parameter associated with the first wireless network connection equipment and the second wireless network connection equipment, and a quality of service (QOS) required for the user traffic.

17. A non-transitory computer-readable medium comprising machine-readable instructions that are executable by a processor to:
receive a data stream from at least one of a first wireless network connection equipment and a second wireless network connection equipment, wherein the first wireless network connection equipment comprises a satellite-based multi-path transport protocol, and wherein the second wireless network connection equipment comprises a non-terrestrial-based multi-path transport protocol and the satellite-based multi-path transport protocol;
determine a type of network configuration associated with at least one of the first wireless network connection equipment and the second wireless network connection equipment, based on receiving the data stream;
convert each of the data stream into a first pre-defined data format, based on the determined type of network configuration, wherein the first pre-defined data format corresponds to a network compatible data format;
generate a unified data stream corresponding to the received data stream, based on converting each of the data stream;
determine an appropriate data transmission path between the first wireless network connection equipment and the second wireless network connection equipment, based on each of a plurality of network parameters, upon generating the unified data stream;
switch dynamically between at least one of the first wireless network connection equipment and the second wireless network connection equipment, based on the determined appropriate data transmission path;
modify the unified data stream to a second pre-defined data format compatible with the determined appropriate data transmission path, wherein the second pre-defined data format corresponds to at least one of a non-terrestrial-based multi-path transport protocol format and a satellite-based multi-path transport protocol format; and
provide a wide area network (WAN) connectivity comprising the modified data streams, to a user device, through an indoor device associated with the determined appropriate data transmission path, wherein the first wireless network connection equipment comprises the indoor device, and a first outdoor device, and wherein the second wireless network connection equipment comprises the indoor device, and a second outdoor device.

18. The non-transitory computer-readable medium of claim 17, wherein for determining the appropriate data transmission path between the first wireless network connection equipment and the second wireless network connection equipment, based on each of the plurality of network parameters, the processor is to:
determine a quality of service (QOS) required for a user traffic associated with the generated unified data stream;
classify the user traffic associated with the generated unified data stream, based on determining the quality of service (QOS); and
determine at least one of a latency parameter and a bandwidth parameter associated with the first wireless network connection equipment and the second wireless network connection equipment, upon classifying the user traffic.

19. The non-transitory computer-readable medium of claim 17, the processor is to:
establish, via the first wireless network connection equipment, an auxiliary path associated with the first wireless network connection equipment, for transmitting the unified data stream, wherein the unified data stream comprises latency-sensitive Internet Protocol (IP) packets associated with the satellite-based multi-path transport protocol.

20. The non-transitory computer-readable medium of claim 17, the processor is to:
establish via an antenna unit, at least one of a first wireless network mode of communication, and a second wireless network mode of communication, wherein the first outdoor device and the second outdoor device comprises the antenna unit comprising a unified antenna; and
connect, via the antenna unit, to at least one of the first wireless network connection equipment and the second wireless network connection equipment within a frequency band.
